(19) United States
(12) Patent Application Publication
(10) Pub. No.: US 2025/0222409 A1
(43) Pub. Date: Jul. 10, 2025

(54) POROUS MEMBRANES AND METHODS OF MAKING AND USING THEREOF

(71) Applicant: Donaldson Company, Inc., Bloomington, MN (US)

(72) Inventors: Maarten Bastin, Leuven (BE); Mohmed Elleithy, Leuven (BE); Wannes Sambaer, Lubbeek (BE)

(21) Appl. No.: 19/014,963

(22) Filed: Jan. 9, 2025

Related U.S. Application Data
(60) Provisional application No. 63/558,319, filed on Feb. 27, 2024.
(60) Provisional application No. 63/619,542, filed on Jan. 10, 2024.

(51) Int. Cl. B01D 69/02; B01D 67/00; B01D 71/44; B01D 71/68

(52) U.S. Cl. CPC B01D 69/02; B01D 67/0013; B01D 67/0032; B01D 71/441; B01D 71/68; B01D 2323/082; B01D 2325/022; B01D 2325/02833; B01D 2325/02834

(57) ABSTRACT

Polymeric porous membranes, filter containing, and methods of making the polymeric membranes the same are disclosed. The polymeric porous membrane has a first major membrane surface and a second major membrane surface opposite of the first major membrane surface, and a first layer proximate the first major membrane surface, the first layer including a first plurality of pores having a first average pore size. The membrane includes a second layer comprising a second plurality of pores having a second pore size. In some cases, the membrane includes a third layer comprising a third plurality of pores having a third pore size.

### CROSS-REFERENCE TO RELATED APPLICATION

This application claims the benefit of U.S. Provisional Patent Application No. 63/619,542, filed Jan. 10, 2024 and U.S. Provisional Patent Application No. 63/558,319, filed Feb. 27, 2024 each of which is incorporated herein by reference in its entirety.

### FIELD

The present disclosure relates to polymeric porous membranes, filters that include a polymeric porous membrane, methods of making polymeric porous membranes, and methods of using polymeric porous membranes.

### INTRODUCTION

Filtration is a fluid (gas and/or liquid) separation process that may be based on, for example, size exclusion. Porous membranes with suitable pore sizes can be used as filters. The ability of a component (particle, molecule, or the like) of a fluid to traverse the membrane depends, at least in part, on the size of the component relative to the size of the pores of the membrane. Fluid components having a size larger than the pores of the membrane will not pass through the membrane, while fluid components having a size smaller than the pores of the membrane will pass through the membrane.

Porous membranes such as microfiltration membranes, ultrafiltration membranes, and/or nanofiltration membranes find many uses including, for example, sterilization, water treatment, plasma fractionalization, virus removal, dewaxing, and protein concentration. The physical and/or chemical properties of a porous membrane are often balanced depending on the intended application of the porous membrane.

Poly(vinylidene fluoride) (PVDF) is one of the most commonly used polymeric porous membrane materials. PVDF membranes can withstand harsh conditions (chemical and thermal) and are mechanically strong. However, some PVDF membranes have low permeation fluxes. For example, some commercially available PVDF membranes have a pure water permeation flux of less than 200 liter per square meter of membrane area per hour (LMH) under 1 bar pressure difference across the membrane. Due to the low flow flux, large membranes may be used to treat large volumes of fluids. For example, in seawater desalination plants, a PVDF filtration unit may include 500,000 square meters of PVDF membranes. The large membrane area may result in a high capital investment and high daily operation costs.

Currently, many polymeric porous membranes are produced via phase separation such as nonsolvent induced phase-separation (NIPS) method and thermally induced phase-separation (TIPS). Complex physical-chemical factors are involved in the phase-inversion process, such as inter-diffusion of solvent and nonsolvent, rheology of the polymer solution, hydrodynamic interfacial instabilities, ambient temperature, and humidity. Therefore, controlling the properties of the final membrane, such as minimal permeation resistance, is challenging.

In the field of material engineering, a freeze casting process is often used to produce porous materials. The freeze casting technique uses solvent crystallization to produce pores, where the solvent crystallites serve as pore-forming templates. Controlling the structural properties of the final membrane using this method is challenging. For example, the pores obtained may be too big for precision separations, and the flux characteristics of the membranes may be suboptimal.

There is a need for polymeric porous membranes having a desired combination of properties for a given application. There is further a need for a method for making such membranes.

### SUMMARY

The present disclosure describes polymeric porous membranes, filter containing the same, and method of making the polymeric porous membranes.

The present disclosure describes a polymeric porous membrane having a first major membrane surface and a second major membrane surface opposite of the first major membrane surface. The membrane includes a first layer proximate the first major membrane surface, the first layer comprising a first plurality of pores having a first average pore size. The membrane includes a second layer comprising a second plurality of pores having a second average pore size, and the second average pore size being greater than the first average pore size. The membrane includes a third layer proximate the second major membrane surface, the third layer comprising a third plurality of pores having a third average pore size, the third average pore size being smaller than second pore size. In some embodiments, the third average pore size is greater than the first average pore size. In some embodiments, the second average pore size is 10 times or greater than the first average pore size. In some embodiments, the second average pore size is 10 times or greater than the third average pore size.

The present disclosure describes a polymeric porous membrane having a first major membrane surface and a second major membrane surface opposite of the first major membrane surface. The membrane includes a first layer proximate the first major membrane surface, the first layer comprising a first plurality of pores having a first average pore size. The membrane includes a second layer comprising a second plurality of pores having a second average pore size, the second average pore size being smaller than the first average pore size. The membrane includes a third layer proximate the second major membrane surface, the third layer comprising a third plurality of pores having a third average pore size, the third average pore size being greater than the second average pore size.

The present disclosure describes a polymeric porous membrane having a first major membrane surface and a second major membrane surface opposite of the first major membrane surface. The membrane includes a first layer proximate the first major membrane surface, the first layer comprising a first plurality of pores having a first average pore size. The membrane includes a second layer comprising a second plurality of pores having a second average pore size, the second average pore size being larger than the first average pore size. In some embodiments, the first average pore size is 20 nanometers (nm) to 499 nm. In some embodiments, the first average pore size is 20 nm to 150 nm such as 20 nm to 125 nm, 20 nm to 100 nm, 20 nm to 90 nm, or 20 nm to 80 nm. In some embodiments, the first average pore size is 100 nm to 250 nm such as 100 nm to 225 nm, 100 nm to 215 nm, or 100 nm to 200 nm. In some embodiments, the second average pore size is 200 nm to 499 nm. In some embodiments, the second average pore size is 0.5 micrometers (μm) to 2 μm such as 0.5 μm to 1 μm.

The present disclosure describes a method of forming the polymeric porous membranes of the present disclosure. The method includes contacting a casting solution with a substrate to form a cast film having a first major filmi surface and a second major film surface opposite of the first film major surface. The first film major surface is in contact with the substrate and forming the first major membrane surface, and the second film major surface being a free surface forming the second membrane major surface. The casting solution includes a casting solvent and a polymer dissolved in the casting solvent. The method includes exposing the first film major surface to a cooling temperature that is less than the melting temperature of the casting solvent for a cooling time to form a cooled cast film. The method includes contacting the cooled cast film with a nonsolvent to remove at least a portion of the casting solvent and to form the cast membrane. The nonsolvent is at a nonsolvent temperature that is equal to or greater than the melting temperature of the casting solvent to from the cast membrane.

The present disclosure describes a method of forming a polymeric porous membrane, the polymeric porous membrane having a first major membrane surface and a second major membrane surface opposite of the first major membrane surface. The method includes a first layer proximate the first major membrane surface. The first layer includes a first plurality of pores having an average pore size. The membrane includes a second layer proximate the second major membrane surface. The second layer includes a second plurality of pores having an average pore size larger than the average pore size of the first plurality of pores. The method includes contacting a casting solution with a substrate to form a cast film having a first major film surface and a second major film surface opposite of the first film major surface. The first film major surface is in contact with the substrate and forming the first major membrane surface, and the second film major surface being a free surface forming the second membrane major surface. The casting solution includes a casting solvent and a polymer dissolved in the casting solvent. The method includes exposing the first film major surface to a cooling temperature that is less than the melting temperature of the casting solvent for a cooling time to form a cooled cast film. The method includes contacting the cooled cast film with a nonsolvent to remove at least a portion of the casting solvent and to form the cast membrane. The nonsolvent may be at a nonsolvent temperature that is equal to or greater than the melting temperature of the casting solvent to from the cast membrane.

The present disclosure describes filters that include a polymeric porous membrane of the present disclosure.

### BRIEF DESCRIPTION OF FIGURES

FIG. 1 is a cross-sectional schematic of a first polymeric porous membrane.

FIG. 2 is a cross-sectional schematic of a second polymeric porous membrane.

FIG. 3 is a cross-sectional schematic of a third polymeric porous membrane.

FIG. 4 is a cross-sectional schematic of a fourth polymeric porous membrane.

FIG. 5 is a cross-sectional schematic of a fifth polymeric porous membrane.

FIG. 6 is an enlarged scanning electron micrograph of a cross-section of a polymeric porous membrane showing the minor axis of various pores.

FIG. 7 is a flow diagram of a method of making a polymeric porous membrane.

FIG. 8 is a scanning electron micrograph of a cross-section of a first poly(ether-sulfone) membrane.

FIG. 9 is a scanning electron micrograph of a cross-section of a second poly(ether-sulfone) membrane.

FIG. 10 is a scanning electron micrograph of a cross-section of a third poly(ether-sulfone) membrane.

FIG. 11 is a scanning electron micrograph of a cross-section of a fourth poly(ether-sulfone) membrane.

FIG. 12 is a scanning electron micrograph of a cross-section of a fifth poly(ether-sulfone) membrane.

FIG. 13 is a scanning electron micrograph of a cross-section of a sixth poly(ether-sulfone) membrane.

FIG. 14 is a scanning electron micrograph of a cross-section of a seventh poly(ether-sulfone) membrane.

FIG. 15 is an example membrane performance plot. d⁻² is the inverse of the average pore diameter (average pore size). The average pore size was measured at the selective layer. CWP is the clean water permeance. r is the radial distance from the origin. A bar over the CWP or d⁻² indicates the value is normalized.

FIG. 16 is a membrane performance plot of various commercial PVDF porous membranes. d⁻² is the inverse of the average pore diameter (average pore size). The average pore size was measured at the selective layer. CWP is the clean water permeance. A bar over the CWP or d⁻² indicates the value is normalized.

FIG. 17 is a membrane performance plot of various commercial PES membranes and membranes formed according to methods of the present disclosure (USC). d⁻² is the inverse of the average pore diameter (average pore size). The average pore size was measured at the selective layer. CWP is the clean water permeance. A bar over the CWP or d⁻² indicates the value is normalized.

FIG. 18 is a membrane performance plot of various PES membranes formed from casting solutions having various concentrations of PES. d⁻² is the inverse of the average pore diameter (average pore size). The average pore size was measured at the selective layer. CWP is the clean water permeance. A bar over the CWP or d⁻² indicates the value is normalized.

FIG. 19 is a membrane performance plot of various PVDF membranes formed from casting solutions having various concentrations of PVDF. d⁻² is the inverse of the average pore diameter (average pore size). The average pore size was measured at the selective layer. CWP is the clean water permeance. A bar over the CWP or d⁻² indicates the value is normalized.

FIG. 20 is a membrane performance plot of various PES membranes of different membrane thickness formed from casting solutions having various concentrations of PES. d⁻² is the inverse of the average pore diameter (average pore size). The average pore size was measured at the selective layer. CWP is the clean water permeance. A bar over the CWP or d⁻² indicates the value is normalized.

FIG. 21 is a membrane performance plot of various PVDF membranes of different membrane thickness formed from casting solutions having various concentrations of PVDF. d⁻² is the inverse of the average pore diameter (average pore size). The average pore size was measured at the selective layer. CWP is the clean water permeance. A bar over the CWP or d⁻² indicates the value is normalized.

FIG. 22 is a membrane performance plot of various PES membranes formed from casting solutions having various concentrations of PES and different cooling temperatures. d⁻² is the inverse of the average pore diameter (average pore size). The average pore size was measured at the selective layer. CWP is the clean water permeance. A bar over the CWP or d⁻² indicates the value is normalized.

FIG. 23 is a membrane performance plot of various PVDF membranes formed from casting solutions having various concentrations of PVDF and different cooling temperatures. d⁻² is the inverse of the average pore diameter (average pore size). The average pore size was measured at the selective layer. CWP is the clean water permeance. A bar over the CWP or d⁻² indicates the value is normalized.

FIG. 24 are scanning electron micrographs of cross-sections of PES porous membranes formed with different cooling times.

FIG. 25 is a membrane performance plot of various PVDF membranes formed from casting solutions having various concentrations of PVDF and different cooling times. d⁻² is the inverse of the average pore diameter (average pore size). The average pore size was measured at the selective layer. CWP is the clean water permeance. A bar over the CWP or d⁻² indicates the value is normalized.

FIG. 26 are scanning electron micrographs of a cross-section of a PVDF porous membrane formed from a method with a 10 seconds(s) cooling time.

FIG. 27 are scanning electron micrographs of a cross-section of a PVDF porous membrane formed from a method with a 120 s cooling time.

FIG. 28 shows a scanning electron micrograph of a cross-section of a porous membrane, a black and white image derived from the scanning electron micrograph, a skeleton image derived from the back and white image, and a close up of a portion of the skeleton image.

FIG. 29 shows a scanning electron micrograph of a cross-section of a porous polymeric membrane and a black and white image derived from the scanning electron micrograph.

FIG. 30A and FIG. 30B are side views of two continuous belt systems that may be used to accomplish methods of the present disclosure.

FIG. 31 is a graphical representation of a theoretical temperature profile of a substrate as the substrate is being exposed to various conditions throughout the membrane formation process.

FIG. 32 is a graphical representation of an experimental temperature profile of a 0.8 millimeter (mm) stainless steel substrate that was substrate was exposed to various conditions throughout the membrane formation process.

FIGS. 33A-33C are graphical representations of computational simulated temperature profiles of 0.8 mm, 2 mm, and 4 mm stainless steel substrates that were exposed to a cooling temperature of −10 degrees Celsius (° C.) (FIG. 33A), −10° C. (FIG. 33B), and −40° C. (FIG. 33C) for 400 seconds.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “alkyl” is used in this disclosure to describe a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, etc.

The term “substantially” as used here has the same meaning as “significantly.” and can be understood to modify the term that follows by at least about 90%, at least about 95%, or at least about 98%. The term “substantially free” of a particular compound means that the compositions of the present disclosure contain less than 1,000 parts per million (ppm) of the recited compound. The term “essentially free” of a particular compound means that the compositions of the present disclosure contain less than 100 parts per million (ppm) of the recited compound. The term “completely free” of a particular compound means that the compositions of the present disclosure contain less than 20 parts per billion (ppb) of the recited compound. In the context of the aforementioned phrases, the compositions of the present disclosure contain less than the aforementioned amount of the compound whether the compound itself is present in unreacted form or has been reacted with one or more other materials.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as +5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (for example, 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range. The value of a parameter or characteristic also can be characterized by a range having endpoints defined by any a minimum value identified for the parameter or characteristic and any maximum value identified for the parameter or characteristic that is greater than the selected minimum value. In certain embodiments, the value of the parameter or the characteristic can be equal to any minimum value or any maximum value listed for that parameter.

As used herein, “have,” “has,” “having.” “include,” “includes,” “including,” “comprise,” “comprises,” “comprising” or the like are used in their open-ended inclusive sense, and generally mean “include, but not limited to,” “includes, but not limited to,” or “including, but not limited to.” Further, wherever embodiments are described herein with the language “have.” “has,” “having.” “include,” “includes,” “including,” “comprise,” “comprises,” “comprising” and the like, otherwise analogous embodiments described in terms of “consisting of” and/or “consisting essentially of” are also provided. The term “consisting of” means including, and limited to, that which follows the phrase “consisting of.” That is, “consisting of” indicates that the listed elements are required or mandatory, and that no other elements may be present. The term “consisting essentially of” indicates that any elements listed after the phrase are included, and that other elements than those listed may be included provided that those elements do not interfere with or contribute to the activity or action specified in the disclosure for the listed elements.

As used herein, the word “exemplary” means to serve as an illustrative example and should not be construed as preferred or advantageous over other embodiments.

As used herein, the terms “preferred” and “preferably” refer to embodiments of the disclosure that may afford certain benefits under certain circumstances. However, other embodiments may also be preferred under the same or other circumstances. Furthermore, the recitation of one or more preferred embodiments does not imply that other embodiments are not useful and is not intended to exclude other embodiments from the scope of the disclosure.

In the disclosure, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this disclosure are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

In several places throughout the disclosure, guidance is provided through lists of examples, which examples can be used in various combinations. In each instance, the recited list serves only as a representative group and should not be interpreted as an exclusive list.

For any method disclosed herein that includes discrete steps, the steps may be performed in any feasible order. And, as appropriate, any combination of two or more steps may be performed simultaneously.

Any direction referred to here, such as “top,” “bottom,” “left.” “right,” “upper,” “lower,” and other directions and orientations are described herein for clarity in reference to the figures and are not to be limiting of an actual device or system or use of the device or system. Devices or systems as described herein may be used in a number of directions and orientations.

A “sulfonated” molecule carries at least one sulfonate (or also referred to as “sulfo”) residue of the type —SO₃H, or the corresponding metal salt form thereof of the type —SO₃⁻M, like an alkali metal salt form with M being, for example Na, K or Li.

### DETAILED DESCRIPTION

The present disclosure relates to polymeric porous membranes, methods of making polymeric porous membranes, and methods of using polymeric porous membranes. A polymeric porous membrane may be included in a filter such as a microfiltration filter, an ultrafiltration filter, or both. For example, a polymeric porous membrane may be included as a substrate for a nanofiltration membrane, reverse osmoses membrane, or gas separation membrane. The polymeric porous membrane, or filter containing the same, may be used in dead-end filtration and/or in crossflow or tangential flow filtration applications.

The present disclosure provides polymeric porous membranes. A membrane is a sheet of material having a first major membrane surface and a second major membrane surface that opposes the first major membrane surface, each major membrane surface defining two major dimensions (for example, length and width). A membrane also has a thickness that may be several orders of magnitude smaller than the largest major dimension. The thickness of the membrane may be substantially uniform or not uniform. The interior structural morphology (the structure between the first major membrane surface and the second major membrane surface) may vary across different areas of the membrane. The interior structural morphology may be assessed by examining a cross-section of a polymeric porous membranes, for example by microscopy (for example, scanning electron microscopy).

The polymeric porous membranes include and/or are made of one or more polymers. Polymeric porous membranes may include, for example, one or more of the following polymers: cellulose tri-acetate; poly(vinylidene fluoride); poly(ether ketone); sulfonated poly(ether ketone); poly(benzimidazole); poly(sulfone); poly(ether sulfone); cellulose acetate; regenerated cellulose; poly(acrylonitrile); poly(methyl acrylate); sulfonated poly(benzimidazole); poly(imide); poly(lactic acid); poly(vinyl alcohol); poly(vinyl chloride); poly(methyl methacrylate); ethylene vinyl alcohol copolymer; poly(L-lactide); poly(DL-lactide); poly(ether ether ketone); sulfonated poly(ether ether ketone); oligodimethylsiloxane-grafted aromatic poly(amide-imide) copolymer; perfluorosulfonated poly(arylene ether sulfone) multiblock copolymer; and cyclodextrin polymer. In some embodiments, the polymeric porous membrane includes and/or is made of poly(vinylidene fluoride), poly(ether sulfone), cellulose acetate, cellulose tri-acetate, or any combination thereof. In some embodiments, the polymeric porous membrane includes and/or is made of poly(vinylidene fluoride) or poly(ether sulfone). In some embodiments, the polymeric porous membrane includes and/or is made of cellulose acetate or cellulose tri-acetate. In some embodiments, the polymeric porous membrane includes and/or is made of poly(vinylidene fluoride). In some embodiments, the polymeric porous membrane includes and/or is made of poly(ether sulfone). In some embodiments, the polymeric porous membrane includes and/or is made of cellulose acetate. In some embodiments, the polymeric porous membrane includes and/or is made of cellulose tri-acetate.

In some embodiments, the polymeric porous membrane includes and/or is made of one or more polymers in a solution that has a viscosity of 1 pascal second (Pa-s) or greater, 5 Pa-s or greater, 10 Pa-s or greater, 20 Pa-s or greater, 30 Pa-s or greater, 40 Pa-s or greater, 50 Pa-s or greater, 60 Pa-s or greater, 70 Pa-s or greater, 80 Pa-s or greater, or 90 Pa-s or greater as measured using a viscometer at 25° C. with a shear rate of zero. In some embodiments, the polymeric porous membrane includes and/or is made of one or more polymers in a solution that has a viscosity of 100 Pa-s or less, 90 Pa-s or less, 80 Pa-s or less, 70 Pa-s or less, 60 Pa-s or less, 50 Pa-s or less, 40 Pa-s or less, 30 Pa-s or less, 20 Pa-s or less, 10 Pa-s, or 5 Pa-s or less as measured using a viscometer at 25° C. with a shear rate of zero.

The polymeric porous membranes can include and/or are made of one or more polymers that are semi-crystalline. A semi-crystalline polymer has a percent crystallinity of 20% or greater. Examples of semi-crystalline polymers that maybe included or form a polymeric porous membrane include ethylene vinyl alcohol copolymer, poly(vinylidene fluoride); poly(ether ketone); ethylene vinyl alcohol copolymer; poly(ether ether ketone); cellulose; and any combination thereof.

The polymeric porous membranes can include and/or are made of one or more polymers that are amorphous. An amorphous polymer has a percent crystallinity of less than 20%. Examples of amorphous polymers that maybe included or form a polymeric porous membrane include poly(benzimidazole), poly(sulfone); poly(ether-sulfone); cellulose acetate; poly(imide); poly(vinyl chloride); poly(methyl methacrylate).

X-ray diffraction may be used to determine if there are crystal domains within the polymer or if the polymer is completely amorphous. Percent crystallinity can be determined using differential scanning calorimetry (DSC). Percent crystallinity may be measured as the ratio of heat of melting of the sample material to the heat of melting of material if the material was 100% crystalline.

The polymeric porous membranes may be continuous membranes. Continuous membranes may be constructed as a single polymeric sheet. Continuous polymeric porous membranes may be made by casting techniques such as the methods disclosed herein.

Although the polymeric porous membranes of the disclosure may be continuous, the interior structural morphology may vary across different regions of the membrane. Such different regions may be described as layers. A polymeric porous membrane includes two or more layers. Each layer may be arranged substantially in parallel with the first major membrane surface and/or the second major membrane surface. Each layer may be characterized by the pore morphology and/or size of at least some of the pores that reside in that layer. Some layers may have larger pores than other layers. It is understood that pores in different layers may be interconnected to form a pore network spanning the thickness of the membrane. The pore network makes the membrane permeable and allows fluid flow through the membrane.

Each layer may include one or more pluralities of pores. Each plurality of pores has an average pore size. The average pore size is the average pore size of a plurality of pores located within a layer. The average pore size of a plurality of pores located within a layer is measured as if the layer was isolated from the rest of the membrane. The average pores size can be measured using the Gas Liquid Porometry Test Method or the Image Analysis Average Pore Size Test Method (see the Examples). The average pore size of a selective layer can be determined using the Gas Liquid Porometry Test Method. The average size pore size of a layer that is not the selective layer can be measured using the Image Analysis Average Pore Size Test Method.

In some embodiments, a polymeric porous membrane may include one or more layers having nanopores. Nanopores are pores having a pore size of less than 500 nm. Nanopores of the present disclosure may have an average pore size of 499 nm or less, 450 nm or less, 400 nm or less, 350 nm or less, 300 nm or less, 250 nm or less, 225 nm or less, 215 nm or less, 200 nm or less, 150 nm or less, 125 nm or less, 115 nm or less, 100 nm or less, 90 nm or less, 80 nm or less, 50 nm or less, 25 nm or less, 15 nm or less, 10 nm or less, 9 nm or less, 8 nm or less, 7 nm or less, 6 nm or less, 5 nm or less, 4 nm or less, 3 nm or less, or 2 nm or less. Nanopores of the present disclosure may have an average pore size of 1 nm or greater, 2 nm or greater, 3 nm or greater, 4 nm or greater, 5 nm or greater, 6 nm or greater, 7 nm or greater, 8 nm or greater, 9 nm or greater, 10 nm or greater, 15 nm or greater, 25 nm or greater, 50 nm or greater, 75 nm or greater, 80 nm or greater, 90 nm or greater, 100 nm or greater, 115 nm or greater, 125 nm or greater, 150 nm or greater, 200 nm or greater, 215 nm or greater, 225 nm or greater, 250 nm or greater, 300 nm or greater, 350 nm or greater, 400 nm or greater, or 450 nm or greater.

In some embodiments, a polymeric porous membrane may include one or more layers having nanopores. Nanopores are pores having a pore size of less than 500 nm. In some embodiments, nanopores are pores having a pore size of 20 nm to 500 nm. Nanopores of the present disclosure may have an average pore size of 499 nm or less, 450 nm or less, 400 nm or less, 350 nm or less, 300 nm or less, 250 nm or less, 225 nm or less, 215 nm or less, 200 nm or less, 150 nm or less, 125 nm or less, 115 nm or less, 100 nm or less, 90 nm or less, 80 nm or less, 50 nm or less, or 25 nm or less. Nanopores of the present disclosure may have an average pore size of 20 nm or greater, 25 nm or greater, 50 nm or greater, 75 nm or greater, 80 nm or greater, 90 nm or greater, 100 nm or greater, 115 nm or greater, 125 nm or greater, 150 nm or greater, 200 nm or greater, 215 nm or greater, 225 nm or greater, 250 nm or greater, 300 nm or greater, 350 nm or greater, 400 nm or greater, or 450 nm or greater.

In some embodiments, the nanopores have an average pore size of 20 nm to 400 nm. In some embodiments, the nanopores have a pore size of 20 nm to 300 nm. In some embodiments, the nanopores have a average pore size of 20 nm to 250 nm. In some embodiments, the nanopores have an average pore size of 20 nm to 225 nm. In some embodiments, the nanopores have an average pore size of 20 nm to 215 nm. In some embodiments, the nanopores have an average pore size of 20 nm to 200 nm.

In some embodiments, the nanopores have an average pore size of 20 nm to 150 nm. In some embodiments, the nanopores have an average pore size of 20 nm to 125 nm. In some embodiments, the nanopores have an average pore size of 20 nm to 115 nm. In some embodiments, the nanopores have an average pore size of 20 nm to 100 nm. In some embodiments, the nanopores have an average pore size of 20 nm to 90 nm. In some embodiments, the nanopores have an average pore size of 20 nm to 80 nm.

In some embodiments, the nanopores have an average pore size of 100 nm to 250 nm. In some embodiments, the nanopores have an average pore size of 100 nm to 225 nm. In some embodiments, the nanopores have an average pore size of 100 nm to 215 nm. In some embodiments, the nanopores have an average pore size of 100 nm to 200 nm.

In some embodiments, the nanopores have an average pores size of 200 nm to 499 nm.

In some embodiments, a polymeric porous membrane may include one or more layers having micropores. Micropores are pores having a pore size of 0.5 μm to 3 μm. Micropores of the present disclosure may have an average pore size of 3 μm or less, 2.75 μm or less, 2.5 μm or less, 2.25 μm or less, 2 μm or less, 1.75 μm or less, 1.5 μm or less. 1.25 μm or less, 1 μm or less, 0.9 μm or less, 0.8 μm or less, 0.7 μm or less, or 0.6 μm or less. Micropores of the present disclosure may have an average pore size of 0.5 μm or greater, 0.6 μm or greater, 0.7 μm or greater, 0.8 μm or greater, 0.9 μm or greater, 1 μm or greater, 1.25 μm or greater, 1.5 μm or greater, 1.75 μm or greater, 2 μm or greater, 2.25 μm or greater, 2.5 μm or greater, or 2.75 μm or greater.

In some embodiments, the micropores have an average pore size of 0.5 μm to 2 μm. In some embodiments, the micropores have an average pore size of 0.5 μm to 1 μm.

In some embodiments, a polymeric porous membrane may include one or more layers having macropores. Macropores are pores having a pore size of greater than 3 μm. Macropores of the present disclosure may have an average pore size of 3.01 μm or greater, 3.5 μm or greater, 4 μm or greater, 4.5 μm or greater, 5 μm or greater, 5.5 μm or greater, 6 μm or greater, 6.5 μm or greater, 7 μm or greater, 7.5 μm or greater, 8 μm or greater, 8.5 μm or greater, 9 μm or greater, 9.5 μm or greater, or 10 μm or greater. Macropores of the present disclosure may have an average pore size of 15 μm or less, 10 μm or less, 9.5 μm or less, 9 μm or less, 8.5 μm or less, 8 μm or less, 7.5 μm or less, 7 μm or less, 6.5 μm or less, 6 μm or less, 5.5 μm or less, 5 μm or less, 4.5 μm or less, 4 μm or less, or 3.5 μm or less.

Adjacent layers may have a discrete pore size boundary where a clear change in average pore size is readily observed. In other cases, pores of different sizes coexist at an interface region between layers. In some embodiments, an average pore size gradient may exist at an interface region between layers and/or across multiple layers. It is understood that pore sizes and average pore sizes of pores of a select layer are measured within the layer, not at the interface between layers.

A polymeric porous membrane may include a selective layer. A selective layer is the layer that determines the maximum size particle and/or molecule that can traverse the membrane. A selective layer has pores having the smallest average pore size compared to other pores in other layers of the polymeric porous membrane. Generally, particles and/or molecules that can traverse the membrane have sizes smaller than the smallest average pore size of the membrane. A selective layer may include a plurality of pores that are nanopores. A selective layer may include a plurality of pores that are micropores.

In some embodiments, a selective layer includes a plurality of pores having an average pore size of 20 nm to 400 nm. In some embodiments, a selective layer includes a plurality of pores having an average pore size of 20 nm to 300 nm. In some embodiments, a selective layer includes a plurality of pores having an average pore size of 20 nm to 250 nm. In some embodiments, a selective layer includes a plurality of pores having an average pore size of 20 nm to 225 nm. In some embodiments, a selective layer includes a plurality of pores having an average pore size of 20 nm to 215 nm. In some embodiments, a selective layer includes a plurality of pores having an average pore size of 20 nm to 200 nm.

In some embodiments, a selective layer includes a plurality of pores having an average pore size of 20 nm to 150 nm. In some embodiments, a selective layer includes a plurality of pores having an average pore size of 20 nm to 125 nm. In some embodiments, a selective layer includes a plurality of pores having an average pore size of 20 nm to 115 nm. In some embodiments, a selective layer includes a plurality of pores having an average pore size of 20 nm to 100 nm. In some embodiments, a selective layer includes a plurality of pores having an average pore size of 20 nm to 90 nm. In some embodiments, a selective layer includes a plurality of pores having an average pore size of 20 nm to 80 nm.

In some embodiments, a selective layer includes a plurality of pores having an average pore size of 100 nm to 250 nm. In some embodiments, a selective layer includes a plurality of pores having an average pore size of 100 nm to 225 nm. In some embodiments a selective layer includes a plurality of pores having an average pore size of 100 nm to 215 nm. In some embodiments, a selective layer includes a plurality of pores having an average pore size of 100 nm to 200 nm.

A polymeric porous membrane may include one or more support layers. A support layer may be a layer having a plurality of pores with an average pore size greater than the selective layer. A polymeric porous membrane may include 1 or more, 2 or more, 3 or more, 4 or more, 5 or more, 6 or more, 7 or more, 8 or more, or 9 or more support layers.

In some embodiments, a support layer includes a plurality of pores having an average pore size of 200 nm to 499 nm. In some embodiments, a support layer includes a plurality of pores having an average pore size of 0.5 μm to 2 μm. In some embodiments, a support layer includes a plurality of pores having an average pore size of 0.5 μm to 1 μm.

In some embodiments, a porous polymeric membrane includes a selective layer adjacent and/or extending from a major membrane surface. In some embodiments, a porous polymeric membrane includes a selective layer that is not adjacent and/or extending from major membrane surface. For example, in some embodiments, a polymeric membrane includes a selective layer sandwiched between two support layers.

Each porous polymeric membrane has a membrane average pore size. In some embodiments, the membrane average pore size is 5 nm or greater, 10 nm or greater, 20 nm or greater, 30 nm or greater, 50 nm or greater, 60 nm or greater, 70 nm or greater, 80 nm or greater, 90 nm or greater, 100 nm or greater, 125 nm or greater, 150 nm or greater, 175 nm or greater, 200 nm or greater, 225 nm or greater, 250 nm or greater, 275 nm or greater, 300 nm or greater, 325 nm of greater, 350 nm or greater, 375 nm or greater, 400 nm or greater, 450 nm or greater, 500 nm or greater, 600 nm or greater, 700 nm or greater, 800 nm or greater, 900 nm or greater, 1000 nm or greater, 1500 nm or greater, 2000 nm or greater, 2250 nm or greater, 2500 nm or greater, 2750 nm or greater, or 3000 nm or greater. In some embodiments, the membrane average pore size is 3500 nm or less, 2750 nm or less, 2500 nm or less, 2250 nm or less, 2000 nm or less, 1500 nm or less, 1000 nm or less, 900 nm or less, 800 nm or less, 700 nm or less, 600 nm or less, 500 nm or less, 450 nm or less, 400 nm or less, 375 nm or less, 350 nm or less, 325 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 40 nm or less, 30 nm or less, 20 nm or less, or 10 nm or less.

The polymeric porous membranes have a thickness. The thickness is the smallest dimension of the membrane. The thickness may be defined as the average thickness across the membrane. In some embodiments, the thickness may be 0.005 mm or greater, 0.01 mm or greater, 0.02 mm or greater, 0.05 mm or greater, 0.07 mm or greater, 0.1 mm or greater, 0.15 mm or greater, 0.2 mm or greater. 0.3 mm or greater, 0.4 mm or greater, 0.5 mm or greater, 0.6 mm or greater, 0.7 mm or greater, 0.8 mm or greater, 0.9 mm or greater, 1 mm or greater, 1.1 mm or greater, 1.2 mm or greater, 1.3 mm or greater, 1.4 mm or greater, 1.5 mm or greater, 1.6 mm or greater, 1.7 mm or greater. 1.8 mm or greater, 1.9 mm or greater, or 2 mm or greater. In some embodiments, the thickness may be 3 mm or less, 2 mm or less, 1.9 mm or less, 1.8 mm or less, 1.7 mm or less, 1.6 mm or less, 1.5 mm or less, 1.4 mm or less, 1.3 mm or less, 1.2 mm or less, 1.1 mm or less, 1 mm or less, 0.9 mm or less, 0.8 mm or less, 0.7 mm or less, 0.6 mm or less, 0.5 mm or less, 0.4 mm or less, 0.3 mm or less, 0.2 mm or less, 0.15 mm or less, 0.1 mm or less, 0.07 mm or less, 0.05 mm or less, 0.1 mm or less, or 0.01 mm or less.

In some embodiments, the thickness of the polymeric porous membrane may be 0.005 mm to 1 mm. In some embodiments, the thickness of the polymeric porous membrane may be 0.005 mm to 0.9 mm. In some embodiments, the thickness of the polymeric porous membrane may be 0.005 mm to 0.8 mm. In some embodiments, the thickness of the polymeric porous membrane may be 0.005 mm to 0.7 mm. In some embodiments, the thickness of the polymeric porous membrane may be 0.005 mm to 0.6 mm. In some embodiments, the thickness of the polymeric porous membrane may be 0.005 mm to 0.5 mm. In some embodiments, the thickness of the polymeric porous membrane may be 0.005 mm to 0.4 mm. In some embodiments, the thickness of the polymeric porous membrane may be 0.005 mm to 0.3 mm. In some embodiments, the thickness of the polymeric porous membrane may be 0.005 mm to 0.2 mm. In some embodiments, the thickness of the polymeric porous membrane may be 0.005 mm to 0.1 mm.

A polymeric porous membrane may have a pore size distribution. The shape of the pore size distribution can be multimodal. In some embodiments, the pore size distribution is bimodal. In some embodiments, the pore size distribution is trimodal. The pore size distribution may be calculated according to the Pore Size Distribution Test Method. In some embodiments, the difference in size of the largest average pore size and the smallest average pore size in a polymeric porous membrane is 0.05 μm or greater, 0.1 μm or greater, 0.2 μm or greater, 0.5 μm or greater, 1 μm or greater, 2 μm or greater, 3 μm or greater, 4 μm or greater, 5 μm or greater, or 10 μm or greater. In some embodiments, the difference in size of the largest average pore size and the smallest average pore size in a polymeric porous membrane is 0.05 μm or greater. In some embodiments, the difference in size of the largest average pore size and the smallest average pore size in a polymeric porous membrane is 0.1 μm or greater. In some embodiments, the difference in size of the largest average pore size and the smallest average pore size in a polymeric porous membrane is 0.2 μm or greater. In some embodiments, the difference in size of the largest average pore size and the smallest average pore size in a polymeric porous membrane is 0.5 μm or greater. In some embodiments, the difference in size of the largest average pore size and the smallest average pore size in a polymeric porous membrane is 1 μm or greater. In some embodiments, the difference in size of the largest average pore size and the smallest average pore size in a polymeric porous membrane is 2 nm or greater. In some embodiments, the difference in size of the largest average pore size and the smallest average pore size in a polymeric porous membrane is 3 μm or greater. In some embodiments, the difference in size of the largest average pore size and the smallest average pore size in a polymeric porous membrane is 4 μm or greater. In some embodiments, the difference in size of the largest average pore size and the smallest average pore size in a polymeric porous membrane is 5 nm or greater. In some embodiments, the difference in size of the largest average pore size and the smallest average pore size in a polymeric porous membrane is 10 μm or greater.

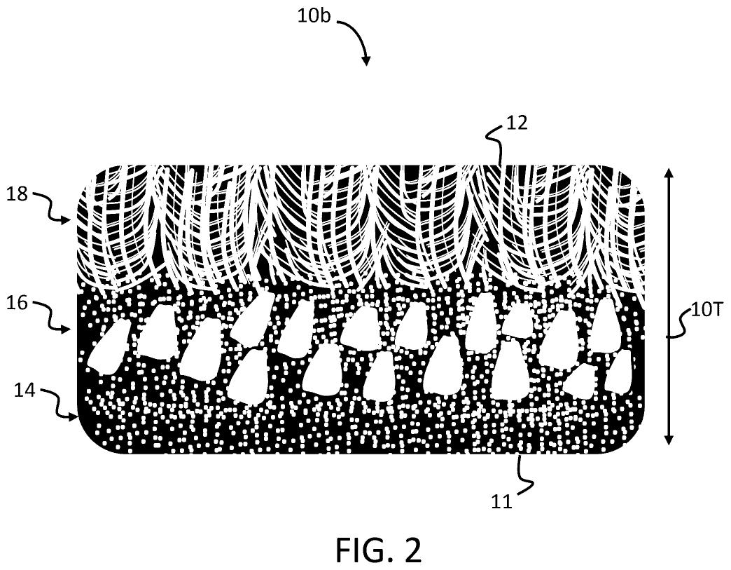

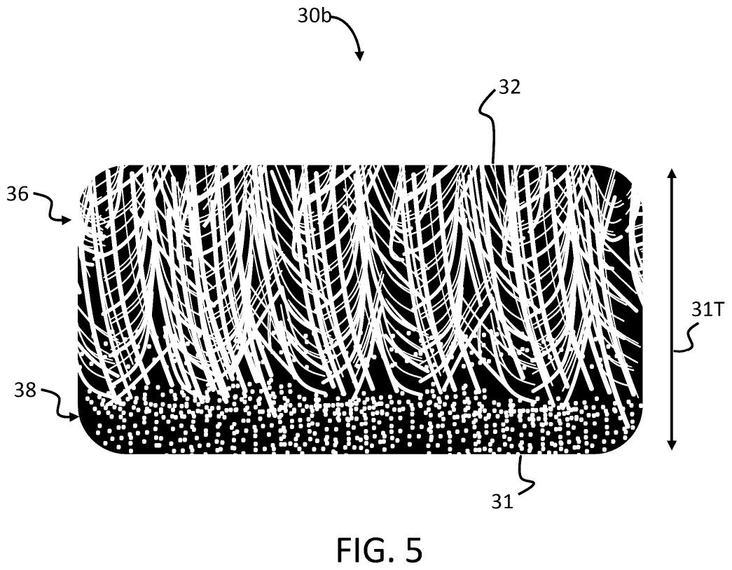

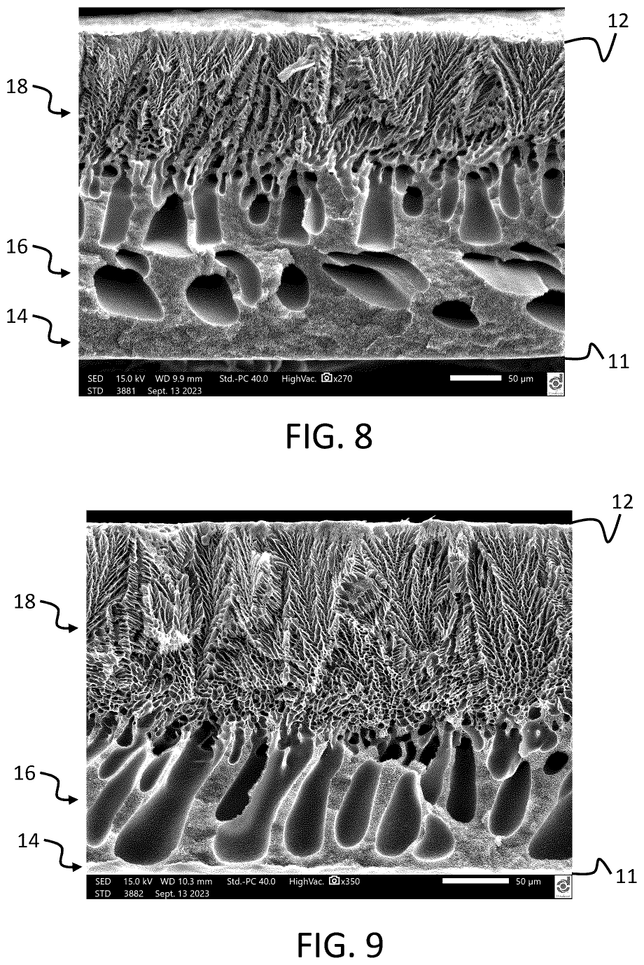

The shape of the pores in a polymeric porous membrane may vary. The pore shape may vary within a plurality of pores or between two or more pluralities of pores. The pore shape may vary between layers of the polymerize porous membrane. For example, a polymeric porous membrane may include a layer that includes a plurality of pores having a channel morphology. FIGS. 2 and 5 are schematics depicting pores with a channel morphology (see layer 18 (FIG. 2) and layer 36 (FIG. 5)). FIGS. 8 and 9 are scanning electron micrographs of polymeric porous membranes having a plurality of pores with a channel morphology (see layer 18). Pores with a channel morphology, also called channel pores, are pores that are elongated. Pore with a channel morphology may be elongated at an angle that is not parallel to the second major membrane surface and/or the first major membrane surface. Stated differently, some channel pores have a major axis that extends at an angle that is not parallel to a major surface. In some cases, pores with a channel morphology extend from a major surface. In some cases, pores with a channel morphology do not extend from a major surface. A channel pore has a major axis and a minor axis. The pore size of the channel pore is measured as the minor axis. Channel pores may be nanopores or micropores. Various channel pores or a plurality of channel pores may be interconnected forming a channel network. In some embodiments, a support layer of a polymeric porous membrane may include pores with a channel morphology. In some embodiments, a selective layer of a polymeric porous membrane may include pores with a channel morphology.

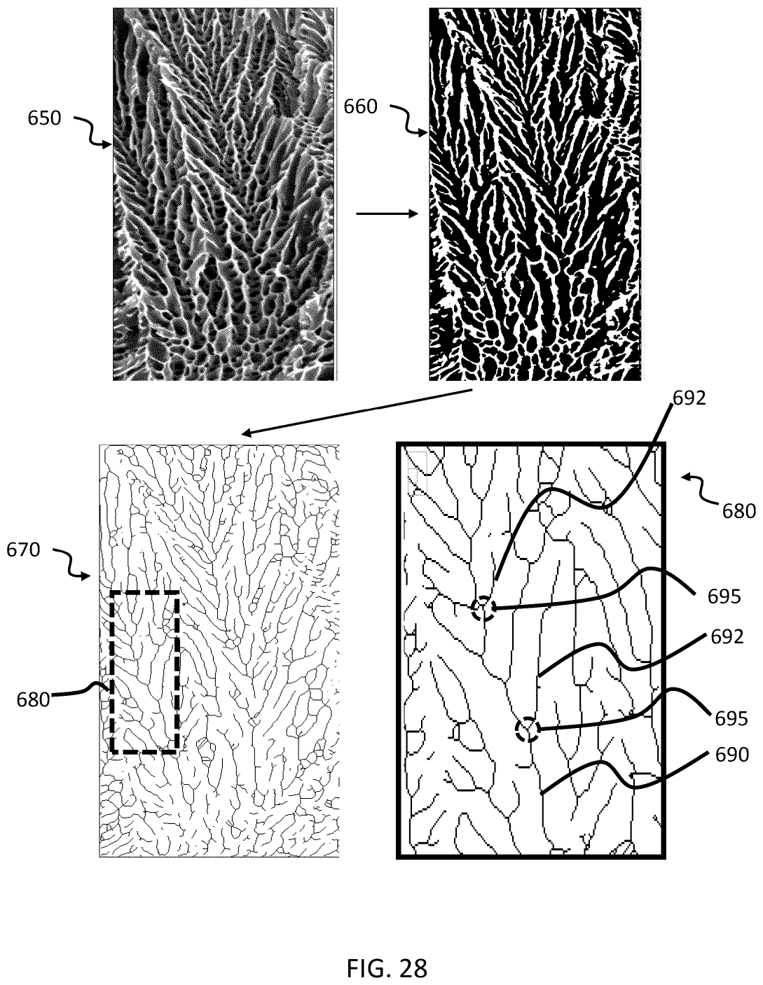

A channel pore may have one or more pore branches extending from the longest (main) channel. The pore branches may be channel pores. The degree of branching for a plurality of channel pores may be determined using Image Analysis on a cross-section SEM image of a porous polymeric membrane. FIG. 28 demonstrates the processes. A cross-section SEM image of channel pores (650) is transformed into a black and white image (660) using an appropriate threshold. The black and white image differentiates pores from polymer material. A skeleton image (670) of the black and white image can be acquired through a skeletonizing algorithm. The skeleton image can be used to calculate the branching density. For example, a blown-up portion (680) of the skeleton image (670) shows a main channel (690) and branch points (695) from which branches (692) extend from the main channel (690).

The performance of a polymeric porous membrane may be characterized by a clean water permeance (CWP). CWP is the rate of clean water flux through the membrane measured as liters per membrane area per hour divided by pressure. CWP is expressed as liters per membrane area per hour per bar (L m⁻²h⁻¹bar⁻¹). In some embodiments, a polymeric porous membrane has a CWP of 1 L m⁻²h⁻¹bar⁻¹ for greater, 25 L m⁻²h⁻¹bar⁻¹ or greater, 50 L m⁻²h⁻¹bar⁻¹ or greater, 60 L m⁻²h⁻¹bar⁻¹ or greater, 75 L m⁻²h⁻¹bar⁻¹ or greater, 100 L m⁻² h⁻¹bar⁻¹ or greater, 150 L m⁻²h⁻¹bar⁻¹ or greater, 200 L m⁻²h⁻¹bar⁻¹ or greater, 250 L m⁻²h⁻¹bar⁻¹ or greater, 300 L m⁻³h⁻¹bar⁻¹ or greater, 350 L m⁻²h⁻¹bar⁻¹ or greater, 400 L m⁻²bar⁻¹ or greater, 450 L m⁻²h⁻¹bar⁻¹ or greater, 500 L m⁻²h⁻¹bar⁻¹ or greater, 600 L m⁻²h⁻¹bar⁻¹ or greater, 700 L m⁻²h⁻¹bar⁻¹ or greater, 800 L m⁻²h⁻¹bar⁻¹ or greater, 900 L m⁻¹bar⁻¹ or greater, 1000 L m⁻²h⁻¹bar⁻¹ or greater, 1100 L m⁻²h⁻¹bar⁻¹ or greater, 1200 L m⁻²h⁻¹bar⁻¹ or greater, 2000 L m⁻²h⁻¹bar⁻¹ or greater, 3000 L m⁻²h⁻¹bar⁻¹ or greater, 4000 L m⁻² h⁻¹bar⁻¹ or greater, 5000 L m⁻²h⁻¹bar⁻¹ or greater, 6000 L m⁻²h⁻¹bar⁻¹ or greater, 7000 L m⁻²h⁻¹bar⁻¹ or greater, 8000 L m⁻²h⁻¹bar⁻¹ or greater, 9000 L m⁻²h⁻¹bar⁻¹ or greater, 10000 L m⁻²h⁻¹bar⁻¹ or greater, 11000 L m⁻²h⁻¹bar⁻¹ or greater, 12000 L m⁻²h⁻¹bar⁻¹ or greater, 15000 L m⁻²h⁻¹bar⁻¹ or greater, 20000 L m⁻²h⁻¹bar or greater, 30000 L m⁻²h⁻¹bar⁻¹ or greater, 40000 L m⁻²h⁻¹bar⁻¹ or greater, 50000 L m⁻²h⁻¹bar⁻¹ or greater, 60000 L m⁻²h⁻¹bar⁻¹ or greater, 70000 L m⁻²h⁻¹bar⁻¹ or greater, or 80000 L m⁻²h⁻¹bar⁻¹ or greater, 90000 L m⁻²h⁻¹bar for greater, 100000 L m⁻²h⁻¹bar⁻¹ or greater, 200000 L m⁻²h⁻¹bar⁻¹ or greater, 300000 L m⁻²h⁻¹bar⁻¹ or greater, 400000 L m⁻²h⁻¹bar⁻¹ for greater, 500000 L m⁻²h⁻¹bar⁻¹ or greater, 600000 L m⁻²h⁻¹bar⁻¹ or greater, 700000 L m⁻²h⁻¹bar⁻¹ or greater, or 800000 L m⁻²h⁻¹bar⁻¹ or greater. In some embodiments, a polymeric porous membrane has a CWP of 900000 L m⁻²h⁻¹bar⁻¹ or less, 800000 L m⁻²h⁻¹bar⁻¹ or less, 700000 L m⁻²h⁻¹bar⁻¹ for less, 600000 L m⁻²h⁻¹bar⁻¹ for less, 500000 L m⁻²h⁻¹bar⁻¹ for less, 400000 L m⁻²h⁻¹bar⁻¹ or less, 300000 L m⁻²h⁻¹bar⁻¹ or less, 200000 L m⁻²h⁻¹bar⁻¹ for less, 100000 L m⁻²h⁻¹bar⁻¹ or less, 90000 L m⁻²h⁻¹bar⁻¹ for less, 80000 L m⁻²h⁻¹bar⁻¹ or less, 70000 L m⁻²h⁻¹bar⁻¹ for less, 60000 L m⁻²h⁻¹bar⁻¹ for less, 50000 L m⁻²h⁻¹bar⁻¹ for less, 40000 L m⁻²h⁻¹bar⁻¹ or less, 30000 L m⁻²h⁻¹bar⁻¹ for less, 20000 L m⁻²h⁻¹bar⁻¹ or less, 15000 L m⁻²h⁻¹bar⁻¹ or less, 12000 L m⁻²h⁻¹bar⁻¹ or less, 11000 L m⁻²h⁻¹bar⁻¹ or less, 10000 L m⁻²h⁻¹bar⁻¹ or less, 9000 L m⁻²h⁻¹bar⁻¹ or less, 8000 L m⁻²h⁻¹bar⁻¹ or less, 7000 L m⁻²h⁻¹bar⁻¹ or less, 6000 L m⁻²h⁻¹bar⁻¹ or less. 5000 L m⁻²h⁻¹bar⁻¹ or less, 4000 L m⁻²h⁻¹bar⁻¹ or less, 3000 L m⁻³h⁻¹bar⁻¹ or less, 2000 L m⁻²h⁻¹bar⁻¹ or less, 1200 L m⁻²h⁻¹bar⁻¹ or less, 1100 L m⁻²h⁻¹bar⁻¹ or less, 1000 L m⁻²h⁻¹bar⁻¹ or less, 900 L m⁻²h⁻¹bar⁻¹ or less, 800 L m⁻²h⁻¹bar⁻¹ or less, 700 L m⁻²h⁻¹bar⁻¹ or less, 600 L m⁻²h⁻¹bar⁻¹ or less, 500 L m⁻²h⁻¹bar⁻¹ or less, 450 L m⁻²h⁻¹bar⁻¹ or less, 400 L m⁻²h⁻¹bar⁻¹ or less, 350 L m⁻²h⁻¹bar⁻¹ of less, 300 L m⁻²h⁻¹bar⁻¹ or less, 250 L m⁻²h⁻¹bar⁻¹ or less, 200 L m⁻²h⁻¹bar⁻¹ or less, 150 L m⁻²h⁻¹bar⁻¹, 100 L m⁻²h⁻¹bar⁻¹ or less, 75 L m⁻²h⁻¹bar⁻¹ or less, 60 L m⁻²h⁻¹bar⁻¹ or less, 60 L m⁻²h⁻¹bar⁻¹ or less, or 25 L m⁻²h⁻¹bar⁻¹ or less.

In some embodiments, a polymeric porous membrane has a CWP of 25 L m⁻²h⁻¹bar⁻¹ to 1200 L m⁻²h⁻¹bar⁻¹. In some embodiments, a polymeric porous membrane has a CWP of 50 L m⁻²h⁻¹bar⁻¹ to 1100 L m⁻²h⁻¹bar⁻¹. In some embodiments, a polymeric porous membrane has a CWP of 60 L m⁻²h⁻¹bar⁻¹ to 1000 L m⁻²h⁻¹bar⁻¹. In some embodiments, a polymeric porous membrane has a CWP of 50 L m⁻²h⁻¹bar⁻¹ to 1000 L m⁻²h⁻¹bar⁻¹.

In some embodiments, a polymeric porous membrane has a CWP of 4000 L m⁻²h⁻¹bar⁻¹ to 15000 L m⁻²h⁻¹bar⁻¹. In some embodiments, a polymeric porous membrane has a CWP of 4000 L m⁻²h⁻¹bar⁻¹ to 12000 L m⁻²h⁻¹bar⁻¹). In some embodiments, a polymeric porous membrane has a CWP of 5000 L m⁼²h⁻¹bar⁻¹ to 12000 L m⁻²h⁻¹bar⁻¹.

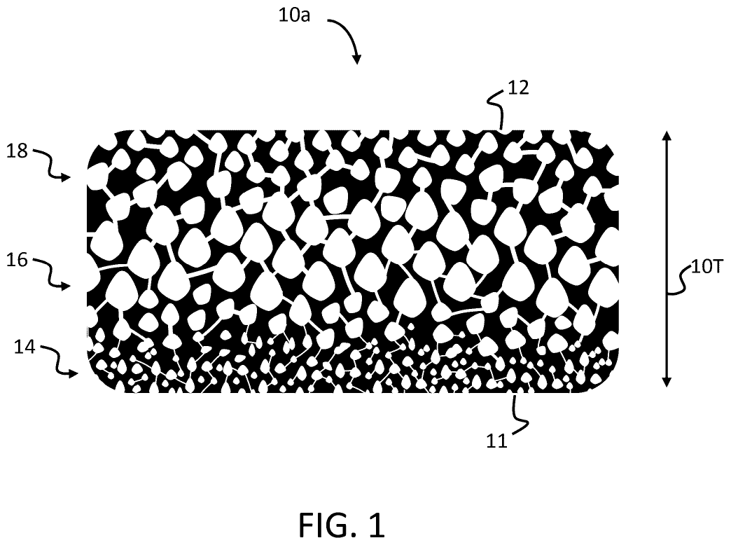

The polymeric porous membranes of the present disclosure may be understood in reference to the cross-sectional schematics of the membranes depicted in FIGS. 1-4.

FIGS. 1 and 2 depict the cross-section of a first polymeric porous membrane 10a and a second polymeric porous membrane 10b consistent with one or more embodiments of the present disclosure. The membrane 10a/10b has a first major membrane surface 11 and a second major membrane surface 12. The first major membrane surface 11 is opposite the second major membrane surface 12. The membrane 10a/10b has a thickness 10T. The thickness may be any thickness as described herein. The membrane 10a/10b includes a first layer 14, a second layer 16, and a third layer 18. The first layer 14 is proximate to the first major membrane surface 11. In some embodiments, the first layer 14 extends from the first major membrane surface 11 toward the second major membrane surface 12. The third layer 18 is proximate to the second major membrane surface 12. In some embodiments, the third layer 18 extends from the second major membrane surface 12 towards the first major membrane surface 11. The second layer 16 is located between the first layer 14 and the third layer 18.

Each layer (14, 16, and 18) of the polymeric porous membrane 10a/10b includes a plurality of pores. The first layer 14 includes a first plurality of pores having a first average pore size. The second layer 16 includes a second plurality of pores having a second average pore size. The third layer 18 includes a third plurality of pores having a third average pore size. The second average pore size is greater than the first average pore size. The third average pore size is smaller than the second average pore size. In some embodiments, the third average pore size is larger than the first average pore size. In some embodiments, the third average pore size is smaller than the first average pore size. In some embodiments, there is a gradient between the first plurality of pores, the second plurality of pores, and the third plurality of pores.

In some embodiments, the first average pore size of the polymeric porous membrane 10a/10b is the smallest average pore size of the polymeric porous membrane. In some such embodiments, the first layer is a selective layer. In some embodiments, the second layer and the third layer are support layers.

In some embodiments, the first plurality of pores (of the first layer 14) are nanopores (the average pore size is less than 500 nm). In some embodiments, the first plurality of pores are micropores (the average pore size is between 500 nm and 3000 nm).

In some embodiments, the first plurality of pores (of the first layer 14) are nanopores (the average pore size is less than 500 nm or 20 nm to 500 nm), the second plurality of pores (of the second layer 16) are micropores (the average pore size is between 500 nm and 3000 nm), and the third plurality of pores (of the third layer 18) are micropores (the average pore size is between 500 nm and 3000 nm). In some embodiments, the first plurality of pores are nanopores, the second plurality of pores are micropores, and the third plurality of pores are nanopores. In some embodiments, the first plurality of pores are nanopores, the second plurality of pores are nanopores, and the third plurality of pores are nanopores.

In some embodiments, the first plurality of pores (of the first layer 14) are nanopores, the second plurality of pores (of the second layer 16) are macro pores (the average pore size is greater than 3 μm), and the third plurality of pores (of the third layer 18) are nanopores. In some embodiments, the first plurality of pores are nanopores, the second plurality of pores are macro pores, and the third plurality of pores are micropores. In some embodiments, the first plurality of pores are nanopores, the second plurality of pores are macro pores, and the third plurality of pores are nanopores. In some embodiments, the first plurality of pores are micropores, the second plurality of pores are macro pores, and the third plurality of pores are micropores. In some embodiments, the first plurality of pores are micropores, the second plurality of pores are macro pores, and the third plurality of pores are nanopores. In some embodiments, the first plurality of pores are nanopores, the second plurality of pores are nanopores, and the third plurality of pores are nanopores.

In some embodiments, the average pore size of the second plurality of pores (of the second layer 16) is at least 3 times greater than the average pore size of the first plurality of pores (of the first layer 14) and/or of the average pore size of the third plurality of pores (of the third layer 18), at least 5 times greater, at least 10 times greater, at least 15 times greater, at least 20 times greater, at least 25 times greater, at least 30 times greater, at least 40 times greater, at least 50 times greater, at least 60 times greater, at least 70 times greater, at least 80 times greater, at least 90 times greater, at least 100 times greater, at least 125 times greater, at least 150 times greater, at least 175 times greater, at least 200 times greater, at least 300 times greater, at least 400 times greater, or at least 500 times greater than the average pore size of the second plurality of pores and/or of the average pore size of the third plurality of pores. In some embodiments, the average pore size of the second plurality of pores (of the second layer 16) and/or of the average pore size of the third plurality of pores (of the third layer 18) is no more than 1000 times greater than the average pore size of the first plurality of pores (of the first layer 14), no more than 500 times greater, no more than 400 times greater, no more than 300 times greater, no more than 200 times greater, no more than 175 times greater, no more than 150 times of less, no more than 125 times greater, no more than 100 times greater, no more than 90 times greater, no more than 80 times greater, no more than 70 times greater, no more than 60 times greater, no more than 50 times greater, no more than 40 times greater, no more than 30 times greater, no more than 20 times greater, no more than 15 times greater, no more than or 10 times greater, or no more than 5 times greater than the average pore size of the first plurality of pores (of the first layer 14) and/or of the average pore size of the third plurality of pores.

In some embodiments, the average pore size of the second plurality of pores (of the second layer 16) and/or of the average pore size of the third plurality of pores (of the third layer 18) is 3 to 50 times greater than the average pore size of the first plurality of pores (of the first layer 14), In some embodiments, the average pore size of the second plurality of pores (of the second layer 16) and/or of the average pore size of the third plurality of pores (of the third layer 18) is 3 to 25 times greater than the average pore size of the first plurality of pores (of the first layer 14).

The pore shape of the pores in the polymeric porous membrane 10a/10b may vary. In some embodiments, a support layer includes a plurality of pores having a channel morphology. In some embodiments, the third layer of a polymer porous membrane may have pores having a channel morphology. FIGS. 8, 9, 10, 11, and 27 are scanning electron micrographs of polymeric porous membranes having a third layer with pores of a channel morphology.

In some embodiments, a layer of the polymeric porous membrane 10a/10b may include two or more pluralities of pores. For example, as depicted in FIG. 2, in some embodiments, the second layer 16 includes a plurality of macropores and a second plurality of pores having a average pore size smaller than the macropores. The second plurality of pores may be nanopores or micropores.

FIGS. 8, 9, 10, and 11 are scanning electron micrographs of cross-sections of polymeric porous membranes consistent with embodiments of the present disclosure. Each polymeric porous membrane includes a first major membrane surface 11, a second major membrane surface 12, a first layer 14 proximate the first major membrane surface, a second layer 16, and a third layer 18 proximate the second major membrane surface. The first layer 14 includes a plurality of nanopores or micropores. The second layer 16 includes a plurality of macropores. The third layer 18 includes a plurality of micropores or macropores. In some polymeric porous membranes, the plurality of pores of the third layer 18 have a channel morphology.

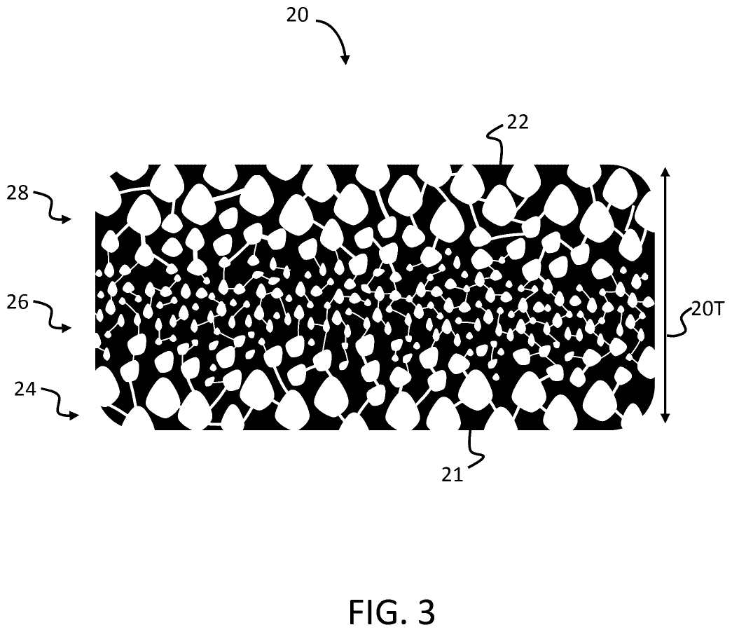

FIG. 3 depicts the cross-section of a third polymeric porous membrane 20 consistent with one or more embodiments of the present disclosure. The membrane 20 has a first major membrane surface 21 and a second major membrane surface 22. The first major membrane surface 21 is opposite the second major membrane surface 22. The membrane 20 has a thickness 20T. The thickness 20T may be any thickness described herein. The membrane 20 includes a first layer 24, a second layer 26, and a third layer 28. The first layer 24 is proximate to the first major membrane surface 21. In some embodiments, the first layer 24 extends from the first major membrane surface 21 towards the second major membrane surface 22. The third layer 28 is proximate to the second major membrane surface 22. In some embodiments, the third layer 28 extends from the second major membrane surface 22 towards the first major membrane surface 21. The second layer 16 is located between the first layer 24 and the third layer 28.

Each layer of the polymeric porous membrane 20 includes a plurality of pores. The first layer 24 includes a first plurality of pores having a first average pore size. The second layer 26 includes a second plurality of pores having a second average pore size. The third layer 28 includes a third plurality of pores having a third average pore size. The second average pore size is smaller than the first average pore size. The third average pore size is larger than the second average pore size. In some embodiments, the third average pore size is larger than the first average pore size. In some embodiments, the third average pore size is smaller than the first average pore size.

In some embodiments, the second average pore size (or the second layer 26) is the smallest average pore size of the polymeric porous membrane 20. In some such embodiments, the second layer may be a selective layer. In some embodiments, the first layer may be a support layer. In some embodiments, the third layer may be a support layer. In some embodiments, the first layer and the second layer may be support layers.

In some embodiments, the first plurality of pores (of the first layer 24) are micropores (the average pore size is between 500 nm and 3000 nm). In some embodiments, the first plurality of pores are macropores (the average pore size is greater than 3 μm). In some embodiments, the first plurality of pores are nanopores.

In some embodiments, the second plurality of pores (of the second layer 26) are micropores. In some embodiments, the second plurality of pores are nanopores (the average pore size is less than 500 nm or 20 nm to 500 nm).

In some embodiments, the third plurality of pores (of the third layer 28) are micropores. In some embodiments, the third plurality of pores are macropores. In some embodiments, the third plurality of pores are nanopores.

In some embodiments, the first plurality of pores (of the first layer 24) are micropores, the second plurality of pores (of the second layer 26) are micropores, and the third plurality of pores (of the third layer 28) are micropores. In some embodiments, the first plurality of pores are micropores, the second plurality of pores are nanopores, and the third plurality of pores are micropores. In some embodiments, the first plurality of pores are macropores, the second plurality of pores are nanopores. and the third plurality of pores are micropores. In some embodiments, the first plurality of pores are micropores, the second plurality of pores are nanopores, and the third plurality of pores are macropores. In some embodiments, the first plurality of pores are macropores, the second plurality of pores are nanopores, and the third plurality of pores are macropores. In some embodiments, the first plurality of pores are micropores, the second plurality of pores are micropores, and the third plurality of pores are macropores. In some embodiments, the first plurality of pores are macropores, the second plurality of pores are micropores, and the third plurality of pores are macropores. In some embodiments, the first plurality of pores are nanopores, the second plurality of pores are nanopores, and the third plurality of pores are nanopores. In some embodiments, the first plurality of pores are micropores or nanopores, the second plurality of pores are nanopores, and the third plurality of pores are nanopores or micropores.

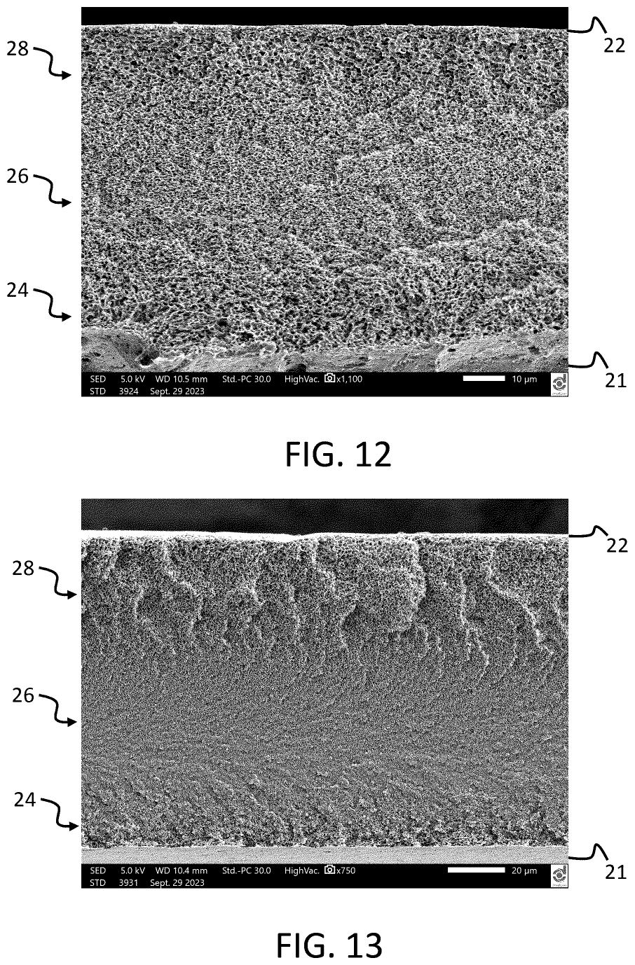

FIGS. 12 and 13 are scanning electron micrographs of cross-sections of polymeric porous membranes consistent with embodiments of the present disclosure. Each polymeric porous membrane includes a first major membrane surface 21, a second major membrane surface 22, a first layer 24 proximate the first major membrane surface, a second layer 26, and a third layer 28 proximate the second major membrane surface. The first layer 24 includes a plurality of nanopores or micropores. The second layer 26 includes a plurality of nanopores or micropores. The third layer 28 includes a plurality of micropores or macropores. The plurality of pores of the second layer have a smaller average pore size than the plurality of pores of the first layer 24 and the plurality of pores of the third layer 28.

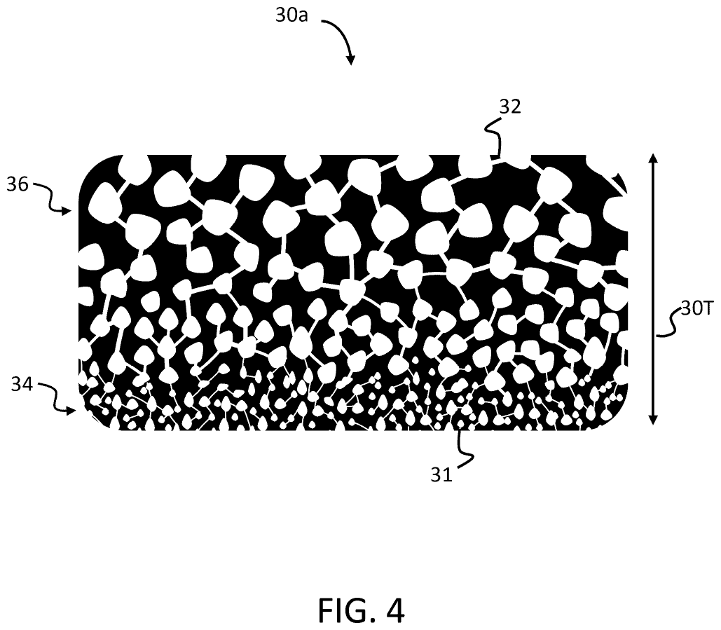

FIGS. 4 and 5 depict the cross-section of a fourth polymeric porous membrane 30a and a fifth polymeric porous membrane 30b consistent with one or more embodiments of the present disclosure. The polymeric porous membranes 30a/30b have a first major membrane surface 31 and a second major membrane surface 32. The first major membrane surface 31 is opposite the second major membrane surface 32. The polymeric porous membranes 30a/30b have a thickness 30T. The thickness 30T may be any thickness disclosed herein. The polymeric porous membranes 30a/30b include a first layer 34 and a second layer 36. The first layer 34 is proximate to the first major membrane surface 31. In some embodiments, the first layer 34 extends from the first major membrane surface 31 toward the second major membrane surface 32. The second layer 36 is proximate to the second major membrane surface 32. In some embodiments, the second layer 36 extends from the second major membrane surface 32 towards the first major membrane surface 31.

Each layer of the polymeric porous membranes 30a/30b include a plurality of pores. The first layer 34 includes a first plurality of pores having a first average pore size. The second layer 36 includes a second plurality of pores having a second average pore size. The second average pore size is larger than the first average pore size.

In some embodiments, the first average pore size of the polymeric porous membranes 30a/30b is the smallest average pore size of the polymeric porous membrane. In such embodiments, the first layer is a selective layer. In some embodiments, the second layer is a support layer.

In some embodiments, the first plurality of pores (of the first layer 34) are nanopores (the average pore size is less than 500 nm or 20 nm to 500 nm). In some embodiments, the first plurality of pores are micropores (the average pore size is between 500 nm and 3000 nm).

In some embodiments, the second plurality of pores (of the second layer 38) are nanopores. In some embodiments, the second plurality of pores (of the second layer 38) are micropores. In some embodiments, the second plurality of pores (of the second layer 38) are macropores.

In some embodiments, the first plurality of pores (of the first layer 34) are nanopores and the second plurality of pores (of the second layer 36) are nanopores. In some embodiments, the first plurality of pores are nanopores and the second plurality of pores are micropores. In some embodiments, the first plurality of pores are nanopores and the second plurality of pores are macropores. In some embodiments, the first plurality of pores are micropores and the second plurality of pores are micropores. In some embodiments, the first plurality of pores are micropores and the second plurality of pores are macropores.

In some embodiments, the first plurality of pores (of the first layer 34) have an average pore size of 20 nm to 400 nm. In some embodiments, the first plurality of pores (of the first layer 34) have an average pore size of 20 nm to 300 nm. In some embodiments, the first plurality of pores (of the first layer 34) have an average pore size of 20 nm to 250 nm. In some embodiments, the first plurality of pores (of the first layer 34) have an average pore size of 20 nm to 225 nm. In some embodiments, the first plurality of pores (of the first layer 34) have an average pore size of 20 nm to 215 nm. In some embodiments, the first plurality of pores (of the first layer 34) have an average pore size of 20 nm to 200 nm.

In some embodiments, the first plurality of pores (of the first layer 34) have an average pore size of 20 nm to 150 nm. In some embodiments, the first plurality of pores (of the first layer 34) have an average pore size of 20 nm to 125 nm. In some embodiments, the first plurality of pores (of the first layer 34) have an average pore size of 20 nm to 115 nm. In some embodiments, the first plurality of pores (of the first layer 34) have an average pore size of 20 nm to 100 nm. In some embodiments, the first plurality of pores (of the first layer 34) have an average pore size of 20 nm to 90 nm. In some embodiments, the first plurality of pores (of the first layer 34) have an average pore size of 20 nm to 80 nm.

In some embodiments, the first plurality of pores (of the first layer 34) have an average pore size of 100 nm to 250 nm. In some embodiments, the first plurality of pores (of the first layer 34) have an average pore size of 100 nm to 225 nm. In some embodiments, the first plurality of pores (of the first layer 34) have an average pore size of 100 nm to 215 nm. In some embodiments, the first plurality of pores (of the first layer 34) have an average pore size of 100 nm to 200 nm.

In some embodiments, the second plurality of pores have an average pore size of 200 nm to 499 nm. In some embodiments, the second plurality of pores have an average pore size of 0.5 μm to 2 μm. In some embodiments, the second plurality of pores have an average pore size of 0.5 μm to 1 μm.

The shape of the pores in the polymeric porous membranes 30a/30b may vary. In some embodiments, a support layer includes a plurality of pores having a channel morphology. In some embodiments, the second layer 36 of a polymer porous membrane may have pores having a channel morphology.

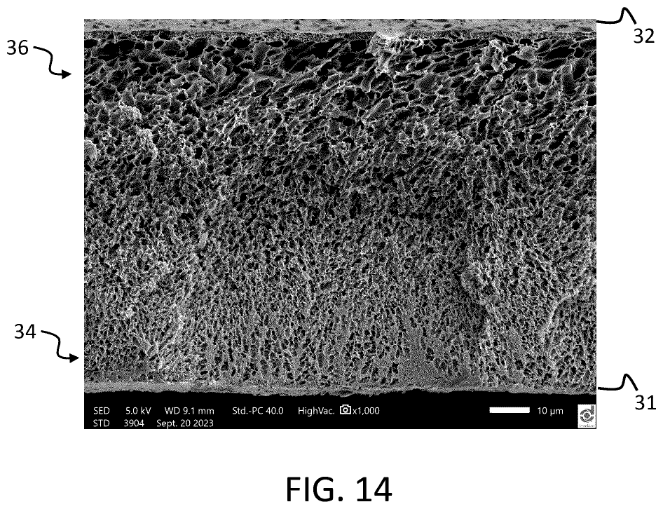

FIG. 14 is scanning electron micrograph of cross-sections of a polymeric porous membrane consistent with embodiments of the present disclosure. The polymeric porous membrane includes a first major membrane surface 31, a second major membrane surface 32, a first layer 34 proximate the first major membrane surface and a second layer 36 proximate the second major membrane surface. The first layer 34 includes a plurality of nanopores or micropores. The second layer 36 includes a plurality of nanopores, micropores, or macropores.

Methods of making the polymer porous membranes of the present disclosure are provided. The methods use a casting technique. As such, the resultant polymeric porous membranes are cast membranes. Generally, casting includes depositing a liquid mixture or solution that includes a polymer onto a substrate and solidifying the polymer to form a solid, such as a polymeric porous membrane.

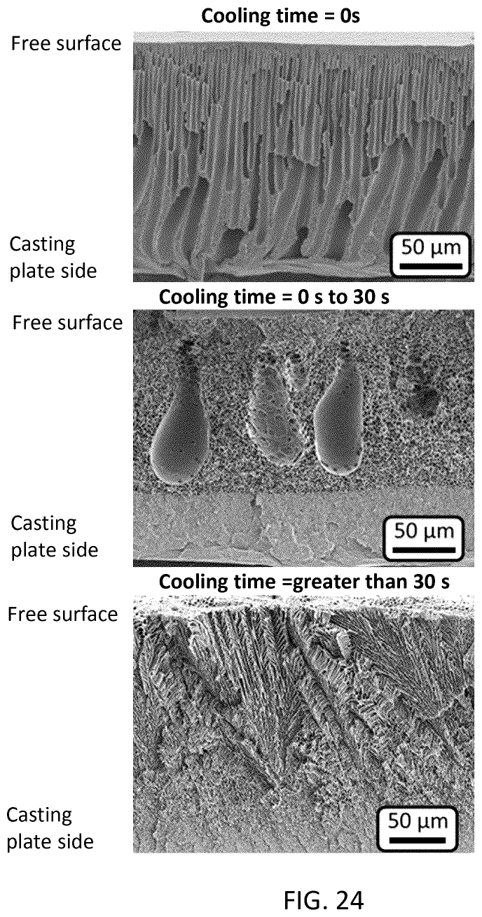

Current membrane casting techniques often include the nonsolvent induced phase-separation (NIPS) method. The NIPS technique generally involves depositing a solution that includes a polymer and a casting solvent onto a casting plate. The deposited solution is then exposed to a nonsolvent that is miscible with the casting solvent but is unable to dissolve the polymer. Immersion precipitation occurs where the thermodynamic equilibrium of the composition is disturbed, demixing takes place, and the polymer solidifies. More specifically, the nonsolvent enters the polymer-casting solvent composition and liquid-liquid demixing occurs. During liquid-liquid demixing, phase separation occurs, causing the solution to form a polymer-rich phase and a polymer-lean phase. The polymer-lean phase starts to form nuclei and will withdraw increasing amount of liquid from the polymer-rich phase. This process will continue until thermodynamic stability is re-established. The polymer-rich phase will solidify and form the polymer matrix of the resulting membrane. If during this process the polymer-lean nuclei grow to such an extent that they can merge, a continuous porous structure is formed. Porous membranes formed by the NIPS method generally have micropores/macropores arranged in columns with little to no branching (for example, see FIG. 24 top). Additionally, porous membranes formed by the NIPS method generally have the smallest pores located at the free side of the film.

Combined crystallization and diffusion (CCD) is another polymeric porous membrane casting technique. CCD is similar to NIPS but includes an additional step which may change the membrane formation process and final membrane characteristics. Similar to the NIPS method, a solution of polymer and a casting solvent is deposited onto a substrate. After deposition, the casting plate is exposed to a reduced temperature from one direction (typically from the direction of the casting plate). The reduced temperature allows the polymeric film to be unidirectionally cooled to a temperature below the freezing temperature of the casting solvent. As the casting solvent is cooled, the casting solvent nucleates and forms casting solvent crystals. The casting solvent crystals serve as pore templates during immersion precipitation (exposure to a nonsolvent) resulting in a polymeric porous membrane. The difference in temperature across the casting solution during cooling creates a temperature gradient. At the colder side of the composition (near the casting plate), crystallization of the solvent occurs and the remaining polymer solution becomes unstable resulting in demixing doe to the reduction of the casting solvent in the liquid phase and the reduced solobility of the polymer at lower temperatures. Upon demixing, the polymer precipitates leading the polymer concentration in the remaining liquid phase to be lower than the adjacent polymer solution at higher temperatures. This concentration gradient drives the polymer solute to diffuse towards the cold end, forming a denser polymer layer near the casting plate as compared to the warmer parts of the composition. After cooling, the cast film is exposed to a nonsolvent which removes the solvent and solvent crystals to form the polymeric porous membrane.

In current CCD methods, the nonsolvent is provided at a temperature below the melting temperature of the solvent (the casting solvent). Providing the nonsolvent at a temperature below the melting temperature of the casting solvent allows the casting solvent to remain solid. It was thought that if the temperature of the nonsolvent was greater than the melting temperature of the solvent, the solvent would melt and could dissolve at least a portion of the formed polymeric porous membrane. Dissolution of the formed polymeric porous membrane may result in larger pores and/or decreased mechanical stability of the membrane.

In contrast to current CCD methods, the methods of the present disclosure provide the nonsolvent at a temperature above (a temperature higher than) the melting temperature of the casting solvent. It was surprisingly found that providing the nonsolvent at a temperature above the melting temperature of the casting solvent results in porous polymeric membranes having various unexpected properties such as those disclosed herein. Without wishing to be bound by theory, it is thought that providing the nonsolvent at a temperature above (a temperature higher than) the melting temperature of the casting solvent will allow for instantaneous demixing of the frozen casting solution and hence preserve the structure of the solvent crystals in the polymer phase.

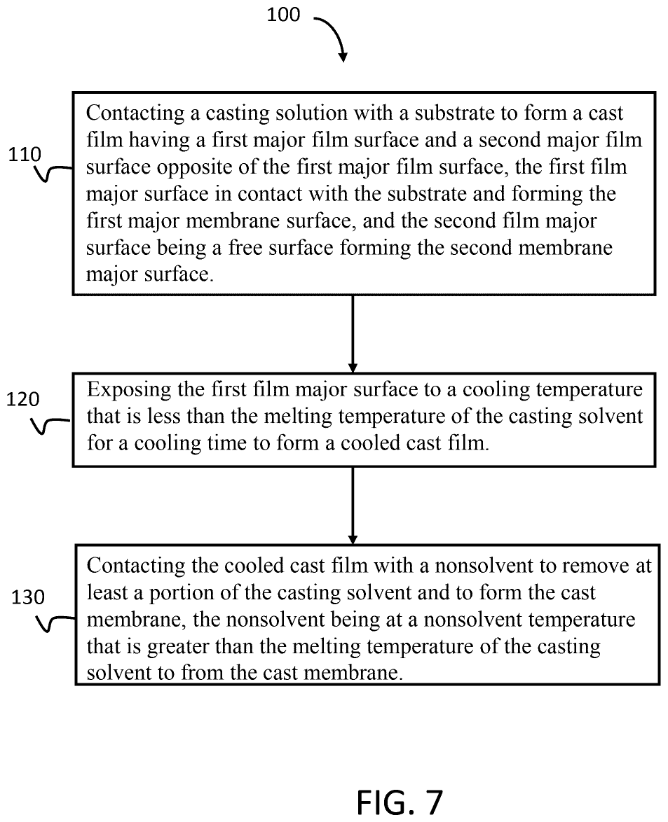

FIG. 7 is a flow diagram of a method 100 for making the polymeric porous membranes of the present disclosure. The method 100 includes contacting a casting solution with a substrate to form a cast film (step 110). The cast film has a first major film surface and a second major film surface opposite the first major film surface. The first major film surface is in contact with the substrate. The first major film surface forms the first major membrane surface of the polymeric porous membrane (for example, 11 in FIGS. 1 and 2, 21 in FIG. 3, and 31 in FIGS. 4 and 5). The second major film surface is a free surface and forms the second major membrane surface of the polymeric porous membrane (for example, 12 in FIGS. 1 and 2, 22 in FIG. 3, and 32 in FIGS. 4 and 5).

The casting solution includes a casting solvent and a polymer. The polymer forms the solid portion of the polymeric porous membrane. The casting solvent may be any solvent or combination of solvents capable of dissolving the chosen polymer. Examples of casting solvents include acetic acid, acetone, acetonitrile, t-butyl alcohol, caprolactam, cyclohexane, dimethylacetamide, dimethylformamide, dimethyl sulfoxide, dioxane, ethyl lactate, glycerin, methylsulfonylmethane, N-methyl pyrrolidone, gamma-valerolactone, valerolactam, caprolactone, caprolactam, hexamethylphosphoroamide, glycerol, sulfolane, tetrahydrofuran, gamma butyrolactone, dimethyl imidazolidine, or any combination thereof. In some embodiments, the casting solvent includes dimethyl sulfoxide, caprolactam, N-methyl pyrrolidone, gamma butyrolactone, or any combination thereof. In some embodiments, the casting solvent includes dimethyl sulfoxide. In some embodiments, the casting solvent includes caprolactam. In some embodiments, the casting solvent includes N-methyl pyrrolidone. In some embodiments, the casting solvent includes caprolactam. in some embodiments, the casting solvent includes gamma butyrolactone. In some embodiments, the casting solvent is free of water.

In some embodiments, the casting solvent has a melting temperature in a range of −110° C. to 80° C. such as 0° C. to 80° C. or 2° C. to 30° C. In some embodiments, the casting solvent has a melting temperature of −110° C. or greater (for example, −110° C. or higher or −110° C. or above), −100° C. or greater, −80° C. or greater, −60° C. or greater, −40° C.′ or greater, −20° C. or greater, −10° C. or greater, 0° C. or greater, 2° C. or greater, 5° C. or greater, 10° C. or greater, 15° C. or greater, 20° C. or greater, 25° C. or greater, 30° C. or greater, 40° C. or greater, 50° C. or greater, 60° C. or greater, 65° C. or greater, 70° C. or greater, or 75° C. or greater. In some embodiments, the casting solvent has a melting temperature of 80° C. or less (for example, 80° C. or lower or 80° C. or below), 75° C. or less, 70° C. or less, 65° C. or less, 60° C. or less, 50° C. or less, 40° C. or less, 30° C. or less, 25° C. or less, 20° C. or less, 15° C. or less, 10° C. or less, 5° C. or less, 2° C.′ or less, 0° C. or less, ˜10° C. or less, ˜20° C. or less, −40° C. or less, −60° C. or less, −80° C. or less, or −100° C. or less. In some embodiments, the casting solvent has a melting temperature in a range of 15° C. to 20° C. or 15° C. to 25° C.

In some embodiments, the casting solvent has a melting temperature of 0° C. to 30° C. In some embodiments, the casting solvent has a melting temperature of 0° C. to 25° C. In some embodiments, the casting solvent has a melting temperature of 0° C. to 20° C. In some embodiments, the casting solvent has a melting temperature of 5° C. to 20° C.

In some embodiments, the casting solvent has a melting temperature of 50° C. to 80° C. In some embodiments, the casting solvent has a melting temperature of 60° C. to 80° C. In some embodiments, the casting solvent has a melting temperature of 60° C. to 70° C. In some embodiments, the casting solvent has a melting temperature of 65° C. to 75° C.

In some embodiments, the casting solvent has a melting temperature of 0° C. to −50° C. In some embodiments, the casting solvent has a melting temperature of −10° C. to −50° C. In some embodiments, the casting solvent has a melting temperature of −10° C. to −40° C. In some embodiments, the casting solvent has a melting temperature of −10° C. to −30° C. In some embodiments, the casting solvent has a melting temperature of −10° C. to −20° C. In some embodiments, the casting solvent has a melting temperature of −20° C. to −60° C. In some embodiments, the casting solvent has a melting temperature of −30° C. to −60° C. In some embodiments, the casting solvent has a melting temperature of −40° C. to −50° C.

In some embodiments, the melting temperature of the casting solvent is greater than (for example, higher than or above), or equal to, the hypothetical lowest stable temperature of the casting solution. The hypothetical lowest stable temperature of the casting solution is understood to be the lowest temperature at which the polymer casting solution is homogenous.

The amount of the polymer in the casting solution may vary. In some embodiments, the casting solution includes 5 wt-% or more, 10 wt-% or more, 15 wt-% or more, 20 wt-% or more, 25 wt-% or more, 30 wt-% or more, 35 wt-% or more, 40 wt-% or more, or 45 wt-% or more of the polymer by total weight of the casting solution. In some embodiments, the casting solution includes 50 wt-% or less, 45 wt-% or less, 40 wt-% or less, 35 wt-% or less, 30 wt-% or less, 25 wt-% or less, 20 wt-% or less, 15 wt-% or less, or 10 wt-% or less of the polymer by total weight of the casting solution. In some embodiments, the casting solution includes 5 wt-% to 35 wt-% of the polymer by the total weight of the casting solution. In some embodiments, the casting solution includes 5 wt-% to 30 wt-% of the polymer by the total weight of the casting solution. In some embodiments, the casting solution includes 10 wt-% to 25 wt-% of the polymer by the total weight of the casting solution.

Examples of polymers that can be included in the casting solution include cellulose tri-acetate, poly(vinyl fluoride); poly(ether ketone); sulfonated poly(ether ketone); poly(benzimidazole); poly(sulfone); poly(ether-sulfone) cellulose acetate; regenerated cellulose; poly(acrylonitrile); poly(methyl acrylate); sulfonated poly(benzimidazole); poly(imide); poly(lactic acid); poly(vinyl alcohol); poly(vinyl chloride); poly(methyl methacrylate); ethylene vinyl alcohol copolymer; poly(L-lactide); poly(DL-lactide); poly(ether ether ketone); sulfonated poly(ether ether ketone); oligodimethylsiloxane-grafted aromatic poly(amide-imide) copolymer; perfluorosulfonated poly(arylene ether sulfone) multiblock copolymer; and cyclodextrin polymer. In some embodiments, the solution includes poly(vinylidene fluoride), poly(ether sulfone), cellulose acetate, or cellulose tri-acetate. In some embodiments, the casting solution includes poly(vinylidene fluoride) or poly(ether sulfone). In some embodiments, the casting solution includes cellulose acetate or cellulose tri-acetate. In some embodiments, the casting solution includes poly(vinylidene fluoride). In some embodiments, the casting solution includes poly(ether sulfone). In some embodiments, the casting solution includes cellulose acetate. In some embodiments, the casting solution includes cellulose tri-acetate.

In some embodiments, the casting solution includes one or more additives. An additive may function to enhance select membrane properties. In some embodiments, additives may be removed from the final polymeric porous membrane, for example, through contact with a nonsolvent (step 130 of method 100, FIG. 7). In some embodiments, additives, or a portion of the additives, may remain in the final membrane. Example additives include polymer additives, nonsolvent additives, nanoparticles, or any combination thereof. Examples of polymer additives include poly(alkylene glycol), alkoxylated poly(alkylene glycol), and poly(vinyl pyrrolidine). Examples of poly(alkylene glycol) include poly(ethylene glycol), poly(propylene glycol), poly(butylene glycol), and any combinations thereof. Examples of alkoxylated poly(alkylene glycol) include methoxy poly(ethylene glycol), methoxy poly(propylene glycol), methoxy poly(butylene glycol), and any combinations thereof. In some embodiments, the casting solution includes poly(ethylene glycol).

An additive, such as a polymer additive may have a number average molecular weight and/or a weight average molecular weight of 0.1 kDa to 50 kDa. For example, in some embodiments, the polymer additive may have number average molecular weight and/or a weight average molecular weight average of 0.1 kDa, 0.5 kDa, 1 kDa to 25 kDa, 1 kDa to 20 kDa, 1 kDa to 15 kDa, 1 kDa to 10 kDa, 1 kDa to 5 kDa, 5 kDa to 20 kDa, 5 kDa to 15 kDa, or 5 kDa to 10 kDa. In some embodiments, a casting solution includes poly(ethylene glycol) having a number average molecular weight and/or a weight average molecular weight average of 5 kDa to 50 kDa, such as, for example, 5 kDa to 10 kDa. The casting solution may include one or more additives. The total amount of the one or more additives in the casting solution may vary. In some embodiments, the total amount of additives in the casting solution is 0.001 wt-% or more, 0.01 wt-% or more, 0.1 wt-% or more, 1 wt-% or more, 2.5 wt-% or more, 5 wt-% or more, or 7.5 wt-% or more based on the total weight of the casting solution. In some embodiments, the total amount of additives in the casting solution is 10 wt-% or less. 7.5 wt-% or less, 5 wt-% or less, 2.5 wt-% or less, 1 wt-% or less, 0.1 wt-% or less, or 0.01 wt-% or less based on the weight of the casting solution.

The material properties of the casting solution may vary. For example, the casting solution may have a density at 25° C., 50° C., and/or 80° C. of 700 grams per cubic decimeter (g/dm³) to 1500 g/dm³, such as 800 g/dm³ to 1200 g/dm³, 900 g/dm³ to 1200 g/dm³, 900 g/dm³ to 1100 g/dm³, 1000 g/dm³ to 1300 g/dm³, or 1000 g/dm³ to 1100 g/dm³. In some embodiments, the casting solution may have a density of 1000 g/dm³ to 1300 g/dm³. The casting solution may have a heat capacity at 25° C. of 0.7 joule per (gram· ° C.) (J/g° C.) to 2.5 J/g° C., such as 0.8 J/g° C. to 2.5 J/g° C., 0.8 J/g° C. to 1.5 J/g° C., 0.9 J/g° C. to 1.4 J/g° C., 1.8 J/g° C. to 2.5 J/g° C., 1.8 J/g° C. to 2.2 J/g° C., 1.0 J/g° C. to 1.4 J/g° C. 1.1 J/g° C. to 1.4 J/g° C., or 1.3 J/g° C. to 1.4 J/g° C. In some embodiments, the casting solution may have a heat capacity at 25° C. of 1.8 J/g° C. to 2.2 J/g° C. The casting solution may have a thermal conductivity at 25° C. and/or 50° C. of 0.1 watts per meter kelvin (W/m·K) to 0.3 W/m·K, such as 0.1 W/m·K to 0.275 W/m·K, 0.125 W/m·K to 0.275 W/m·K, 0.150 W/m·K to 0.275 W/m·K, 0.175 W/m·K to 0.250 W/m·K, 0.175 W/m·K to 0.225 W/m·K, or 0.20 W/m·K to 0.225 W/m·K. The casting solution may have an enthalpy of crystallization of 50 joules per gram (J/g) to 150 J/g. such as 80 J/g to 130 J/g, 80 J/g to 120 J/g, or 90 J/g to 120 J/g. In some embodiments, the casting solution has a density at 25° C., 50° C., and/or 80° C. of 1000 g/dm³ to 1100 g/dm³; a heat capacity at 25° C. of 1.3 J/g° C. to 1.4 J/g° C.; a thermal conductivity at 25° C. and/or 50° C. of 0.20 W/m·K to 0.225 W/m·K; and an enthalpy of crystallization of 90 J/g to 120 J/g.

The substrate on which the casting solution is deposited may be any suitable substrate. The substrate may have a smooth surface. In some embodiments, the substrate has a rough surface or a patterned surface to result in a first major membrane surface that is not smooth and/or is patterned. The substrate may be made of any suitable materials. Example substrate materials include metals such as aluminum, and glass. The substrate may be made of or include stainless steel. The substrate may take any form. For example, the substrate may be, for example, a plate or a belt.

The substrate may have a variety of thicknesses. In some embodiments, the substrate has a thickness of 0.02 mm to 10 mm, such as 0.02 to 10 mm, 0.02 to 9 mm, 0.02 to 8 mm, 0.02 to 7 mm, 0.02 to 6 mm, 0.02 to 5 mm, 0.02 mm to 4 mm, 0.02 mm to 3 mm, 0.02 mm to 2 mm, 0.02 mm to 1 mm, 0.4 mm to 1 mm, 0.6 mm to 1 mm. In some embodiments, the substrate has a thickness of 0.6 mm to 1 mm such as 0.8 mm.

The amount of casting solution per unit area may vary. For example, the amount of casting solution per unit area may be determined at least in part on the desired cast membrane thickness. As such, once deposited onto the substrate the casting solution may have any thickness as described herein relative to the cast membrane thickness.

In some embodiments, step 110 of method 100 (FIG. 7) is carried out at ambient temperature (for example, 22° C. to 25° C.). For example, the casting solution, the substrate, and the environment in which deposition of the casting solution onto the substrate occurs is neither heated nor cooled.

In some embodiments, step 110 is carried out at an elevated temperature. For example, the casting solution and/or the substrate may be heated to a temperature greater than 25° C. (for example, above 25° C. or higher than 25° C.), for example up to 50° C. In some embodiments the environment in which deposition of the casting solution occurs is at an elevated temperature such that the casting solution and/or substrate are exposed to and/or heated to a temperature greater than the ambient temperature. For example, deposition of the casting solution onto the substrate may be done in a heated location.

In some embodiments, the casting solution, the substrate, or both, is at ambient temperature (for example, 22° C. to 25° C.). In other embodiments, the casting solution and/or the substrate is at an elevated temperature.

The method 100 (FIG. 7) further includes exposing the first film major surface of the cast film to a cooling temperature that is less than (lower than) the melting temperature of the casting solvent for a cooling time to form a cooled cast film (step 120). Exposing the first film major surface to a cooling temperature may be done by chilling the substrate such that the first film major surface is exposed to a cooling temperature that is less than the melting temperature of the casting solvent. Stated differently, in some embodiments, step 120 includes chilling the substrate to a cooled temperature that is less than (lower than or below) the melting temperature of the casting solvent for a cooling time to form a cooled cast film. In some embodiments, steps 110 and 120 are accomplished simultaneously. For example, in some embodiments, contacting a casting solution with a substrate includes contacting a casting solution with a substrate that is at the cooling temperature.

Exposing the first film major surface to a cooling temperature by chilling the substrate allows for unidirectional cooling of the cast film. Specifically, since the entire cast film is not exposed to the cooling temperature at once, cooling is not uniform across the cast film. The first film major surface of the cast film is cooled before the rest of the film. Additionally, since cooling is not uniform, a temperature gradient may be created in the cast film where the regions of the cast film proximate to the first film major surface are colder than regions of the cast film further away from the first film major surface.

Chilling of the substrate may be accomplished directly or indirectly. The substrate may be chilled, for example, by placing the substrate on top of a cooled second substrate. The substrate may be chilled, for example, by exposing the substrate, but not the casting solution, to a chilled bath, or the like. For example, at least a portion of the substrate may be contacted or submerged in a chilled bath.

The cooling temperature is the temperature that the first film surface is exposed to. The temperature of a chilled substrate and/or the chilled bath (if used) may serve as a proxy for the cooling temperature. The cooling temperature may be from 10° C. to 120° C. below the melting temperature of the casting solvent (for example, 10° C. to 120° C. less than the melting temperature of the casting solvent or 10° C. to 120° C. lower than the melting temperature of the casting solvent). For example, if the casting solvent had a melting temperature of 20° C., the cooling temperature may be 0° C. to −100° C. In some embodiments, a lower cooling temperature may result in a less permeable membrane as compared to a membrane formed using the same materials and processes but with a higher cooling temperature.

In some embodiments, the cooling temperature may be 10° C. or more below the melting temperature of the casting solvent (for example, 10° C. or more lower than the melting temperature of the casting solvent, or 10° C. or more below the melting temperature of the casting solvent), 20° C. or more below the melting temperature of the casting solvent, 30° C. or more below the melting temperature of the casting solvent, 40° C. or more below the melting temperature of the casting solvent, 50° C. or more below the melting temperature of the casting solvent, 60° C. or more below the melting temperature of the casting solvent, 70° C. or more below the melting temperature of the casting solvent, 80° C. or more below the melting temperature of the casting solvent, 90° C. or more below the melting temperature of the casting solvent, 100° C. or more below the melting temperature of the casting solvent, or 120° C. or more below the melting temperature of the casting solvent. In some embodiments, the cooling temperature may be 120° C.: or less below the melting temperature of the casting solvent, 110° C. or less below the melting temperature of the casting solvent 100° C. or less below the melting temperature of the casting solvent, 90° C. or less below the melting temperature of the casting solvent, 80° C. or less below the melting temperature of the casting solvent, 70° C. or less below the melting temperature of the casting solvent, 60° C. or less below the melting temperature of the casting solvent, 50° C. or less below the melting temperature of the casting solvent, 40° C. or less below the melting temperature of the casting solvent, 30° C. or less below the melting temperature of the casting solvent, or 20° C. or less below the melting temperature of the casting solvent.

In some embodiments, the cooling temperature is 40° C. to 90° C. below (for example, less than or lower than) the melting temperature of the casting solvent. In some embodiments, the cooling temperature is $0° C. to 80° C. below the melting temperature of the casting solvent. In some embodiments, the cooling temperature is 50° C. or more below the melting temperature of the casting solvent.

In some embodiments, the cooling temperature is −180° C. to 50° C. In some embodiments, the cooling temperature is 50° C. or less, 40° C. or less, 30° C. or less, 20° C. or less, 10° C. or less, 0° C. or less, −10° C.′ or less, −20° C.′ or less, −30° C.′ or less, −40° C. or less, −50° C. or less, −60° C. or less, −70° C. or less, −80° C. or less, −90° C. or less, −100° C. or less, −110° C. or less, −120° C. or less, −130° C. or less, −140° C. or less, −150° C. or less, or −160° C. or less. In some embodiments, the cooling temperature is −180° C. or greater, −170° C. or greater, −160° C. or greater, −150° C. or greater, −140° C. or greater, −130° C. or greater, −120° C. or greater, −110° C. or greater, −100° C. or greater, −90° C. or greater, −80° C. or greater, −70° C. or greater, −60° C. or greater, −50° C. or greater, −40° C. or greater, −30° C. or greater, −20° C. or greater, −10° C. or greater. 0° C. or greater, 10° C. or greater, 20° C. or greater, 30° C. or greater, or 40° C. or greater. In some embodiments, the cooling temperature is −80° C. to −10° C. In some embodiments, the cooling temperature is −70° C. to −20° C. In some embodiments, the cooling temperature is −60° C. to −30° C.

The first film major surface is exposed to the cooling temperature for a cooling time. The total time the substrate is exposed to the cooling temperature is used as a proxy for the cooling time. The cooling time may vary. In practice, there may be no maximum cooling time. In some embodiments, the cooling time may be 0.1 second to 24 hours. In some embodiments, the cooling time is 0.1 seconds or greater, 0.5 seconds or greater, 1 second or greater, 5 seconds or greater, 10 seconds or greater, 15 seconds or greater, 20 seconds or greater, 30 seconds or greater, 40 seconds or greater, 50 seconds or greater, 1 minute or greater, 5 minutes or greater, 10 minutes or greater, 30 minutes or greater, 1 hour or greater, 4 hours or greater, 10 hours or greater, 15 hours or greater or 20 hours or greater. In some embodiments, the cooling time is 24 hours or less, 20 hours or less, 15 hours or less, 10 hours or less 5 hours or less, 1 hour or less, 30 min or less. 10 minutes or less, 5 minutes or less, 1 minutes or less, 50 seconds or less, 40 seconds or less, 30 seconds or less. 20 seconds or less, 10 seconds or less, 5 seconds or less, 1 second or less, or 0.5 seconds or less.

In some embodiments, while the first film major surface is exposed to the cooling temperature, the second major film surface is exposed to ambient temperature or an elevated temperature. For example, in some embodiments, during step 120 of method 100, the second major film surface is exposed to a temperature of 22° C. to 80° C., such as 22° C. to 70° C., 22° C. to 60° C., 22° C. to 50° C., 22° C. to 40° C., 22° C. to 30° C., 25° C. to 50° C., 30° C. to 70° C., 30° C. to 70° C., 40° C. to 70° C., or 40° C. to 50° C. In some embodiments, the second major film surface is exposed to temperatures below 22° C., for example −180° C. to 21° C., −160° C. to 21° C., −140° C. to 21° C., −120° C. to 21° C., −100° C. to 21° C., −80° C. to 21° C., −60° C. to 21° C., −40° C. to 21° C., −30° C. to 21° C., −20° C. to 21° C., −10° C. to 21° C., 0° C. to 21° C., 10° C. to 21° C., or 15° C. to 21° C. In some embodiments, while the first film major surface is exposed to the cooling temperature, the second major film surface is exposed to the same temperature as the cooling temperature.

In some embodiments, during step 120 of method 100, the second major film surface is exposed to a temperature of −80° C. to 40° C. In some embodiments, during step 120 of method 100, the second major film surface is exposed to a temperature of −70° C. to 30° C. In some embodiments, during step 120 of method 100, the second major film surface is exposed to a temperature of −60° C. to 22° C. In some embodiments, during step 120 of method 100, the second major film surface is exposed to a temperature of 22° C. to 60° C.

The method 100 further includes contacting the cooled cast film with a nonsolvent to remove at least a portion of the casting solvent and to form the polymeric porous membrane (step 130). The nonsolvent is at a nonsolvent temperature that is equal to or greater than (for example, above or higher than) the melting temperature of the casting solvent. The cooled cast film is contacted with a nonsolvent such as to remove the casting solvent from the cooled cast film to form the polymeric porous membrane.

A nonsolvent may be any solvent that is not capable of dissolving the cast polymer film under the conditions in which it is used (for example, the nonsolvent temperature). In some embodiments, the nonsolvent is miscible with the casting solvent. A nonsolvent that is miscible with the casting solvent may assist with removal of the casting solvent from the cooled cast film. Examples of nonsolvents include water, t-butanol, methanol, ethanol, isopropanol, ethanediol, or any combination thereof. Sulfolane is a nonsolvent that may be combined with one or more other nonsolvents.

Contacting the cooled cast film with a nonsolvent may be accomplished using any suitable technique. For example, the cooled cast film may be submerged into a nonsolvent bath, rinsed with the nonsolvent, or both. The cooled cast film may be contacted with a nonsolvent multiple times or with different solvents one or more times. For example, the cooled cast film may be contacted with one or more nonsolvent baths in series.

The nonsolvent is provided at least partially in a liquid state. In some embodiments, the nonsolvent is provided as a liquid. In other embodiments, the nonsolvent may be provided as a mixture of a solid and a liquid. For example, the nonsolvent may include water or ice water.

In some embodiments, the nonsolvent may have a melting temperature greater than the melting temperature of the casting solvent. In some embodiments, the nonsolvent may have a melting temperature less than the melting temperature of the casting solvent.

In some embodiments where the casting solvent has a melting temperature below ambient temperature and the nonsolvent has a melting temperature less than the melting temperature of the casting solvent, the nonsolvent is provided at ambient temperature. In some embodiments, the nonsolvent is provided at a temperature greater than ambient temperature.

In some embodiments, the nonsolvent is at a nonsolvent temperature that is equal to the melting temperature of the casting solvent or 0.01° C. to 70° C. greater than the melting temperature of the casting solvent. In some embodiments, the nonsolvent is at a temperature that is greater than (for example, higher than or above) the melting temperature of the casting solvent. In some embodiments, the nonsolvent temperature is 0.01° C. or more above the melting temperature of the casting solvent 0.1° C. or more above the melting temperature of the casting solvent, 1° C. or more above the melting temperature of the casting solvent, 2.5° C. or more above the melting temperature of the casting solvent, 5° C. or more above the melting temperature of the casting solvent, 7.5° C. or more above the melting temperature of the casting solvent, 10° C. or more above the melting temperature of the casting solvent, 12.5° C. or more above the melting temperature of the casting solvent, 15° C. or more above the melting temperature of the casting solvent, 20° C. or more above the melting temperature of the casting solvent, 25° C. or more above the melting temperature of the casting solvent, 30° C.′ or more above the melting temperature of the casting solvent, 40° C. or more above the melting temperature of the casting solvent, 50° C. or more above the melting temperature of the casting solvent, or 60° C. or more above the melting temperature of the casting solvent. In some embodiments, the nonsolvent temperature 70° C. or less above the melting temperature of the casting solvent, 60° C. or less above the melting temperature of the casting solvent, 50° C. or less above the melting temperature of the casting solvent, 40° C. or less above the melting temperature of the casting solvent, 30° C. or less above the melting temperature of the casting solvent, 25° C. or less above the melting temperature of the casting solvent 20° C. or less above the melting temperature of the casting solvent, 15° C. or less above the melting temperature of the casting solvent, 12.5° C. or less above the melting temperature of the casting solvent, 10° C. or less above the melting temperature of the casting solvent, 7.5° C.′ or less above the melting temperature of the casting solvent, 5° C. or less above the melting temperature of the casting solvent. 2.5° C. or less above the melting temperature of the casting solvent, 1° C. or less above the melting temperature of the casting solvent, or 0.1° C. or less above the melting temperature of the casting solvent.

In some embodiments, the nonsolvent temperature is 1° C. to 20° C. above (for example, higher than or greater than) the melting temperature of the casting solvent. In some embodiments, the nonsolvent temperature is 1° C. to 15° C. above the melting temperature of the casting solvent. In some embodiments, the nonsolvent temperature is 1° C. to 10° C.′ above the melting temperature of the casting solvent.

In some embodiments, the nonsolvent includes water. In some embodiments, the casting solvent includes dimethyl sulfoxide and the nonsolvent includes water.

In some embodiments, one or more of the steps in method 100 are carried out in a low humidity environment. Deposition in a low humidity environment may be beneficial to inhibit water from entering the casting solution. Water in the casting solution may interrupt the mechanism of membrane formation. Relative humidity is the ratio of partial pressure of water vapor in an air sample to the saturation vapor pressure of water at the same temperature. Relative humidity may be expressed as a percent. In some embodiments, step 110 is carried out in an environment that has a relative humidity of 40% or less, 30% or less, or 20% or less.

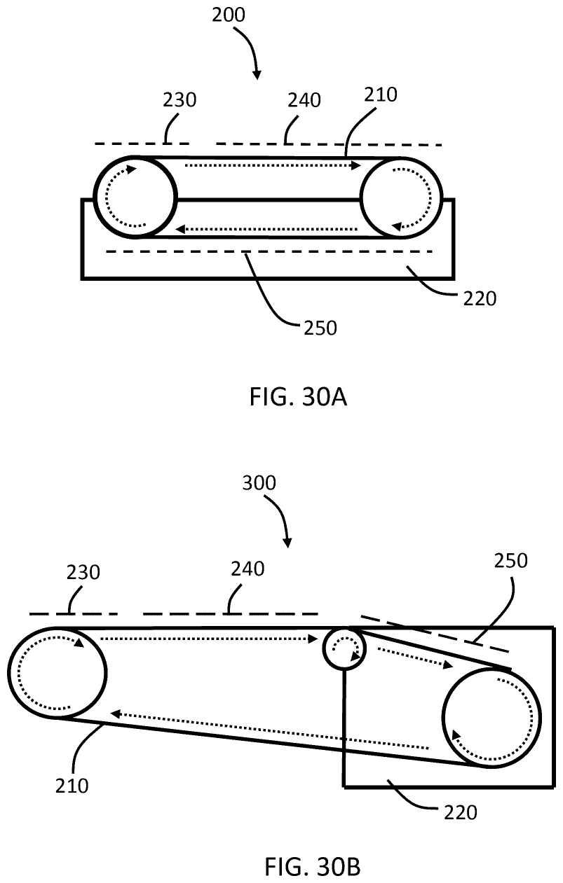

FIG. 30A and FIG. 30B are side views of example systems 200 and 300 configured to accomplish method 100 of FIG. 7. The systems 200 and 300 include a continuous belt 210 and a nonsolvent bath 220. The systems 200 and 300 include three zones, a casting zone 230, a cooling zone 240, and a nonsolvent zone 250. In each of the three zones, the continuous belt 210 and any material deposited on the continuous belt (for example, the casting solution, the cast film, and the cooled cast film) is exposed to different conditions to accomplish method 100 to form a cast membrane (porous polymeric membrane) of the present disclosure. Specifically, as the continuous belt 210 moves, the continuous belt 210 and any material deposited on the continuous belt traverses the casting zone 230, the cooling zone 240, and the nonsolvent zone 250.

The casting zone 230 is the location in the systems 200 and 300 in which the casting solution is deposited on the continuous belt (a substrate) to from a cast film (step 110 of method 100). The casting solution may be continuously or intermittently deposited onto the continuous belt 210 in the casting zone 230. For example, the systems 200 and 300 may further include a mixing vessel configured to deposit the casting solution onto the continuous belt 210 within the casting zone 230. In some embodiments, the continuous belt and/or the environment surrounding the continuous belt within the casting zone is exposed to a temperature from⁻²⁵° C. to 50° C.

The cast film and the portion of the continuous belt on which the cast film is formed enter the cooling zone 240. The cooling zone 240 is the location within the systems 200 and 300 in which the first film major surface of the cast film is exposed to a cooling temperature that is less than the melting temperature of the casting solvent for a cooling time to form a cooled cast film (step 120 of method 100). Within the cooling zone 240, the continuous belt 210 is cooled to the cooling temperature. Any continuous belt cooling technique may be used. For example, within the cooling zone, the continuous belt 210 may be in contact with a cooling bath or a cooling substrate. The cooling temperature may be any temperature as disclosed herein. The environment within the cooling zone 240 may have a low relative humidity (for example, 40% or less, 30% or less, or 20% or less). In some embodiments, the environment within the cooling zone 240 may be at an ambient temperature or an elevated temperature. For example, while the first major film surface is exposed to the cooling temperature, the second major film surface (the film surface not in contact with the continuous belt) may be exposed to a temperature of 22° C. to 80° C.

The cooled cast film enters the nonsolvent zone 250. The nonsolvent zone 250 is the location within the system 200 or 300 where the cooled cast film is contacted with a nonsolvent to remove at least a portion of the casting solvent to form the cast membrane (step 130 of method 100). The nonsolvent is at a nonsolvent temperature that is greater than the melting temperature of the casting solvent. The nonsolvent temperature may be any nonsolvent temperature as disclosed herein. In systems 200, and 300 the nonsolvent is present in the nonsolvent bath 220. Within the nonsolvent zone 250, the continuous belt 210 and the cooled cast membrane deposited on the continuous belt are submerged in the nonsolvent bath 220.

The present disclosure provides filters that include a polymeric porous membrane of the present disclosure. The filters may further include a housing, support materials, additional filtration materials and/or other elements commonly found in filters. The polymeric porous membranes may be employed in microfiltration filters, ultrafiltration filters, and/or nanofiltration filters.

The filter may be used for filtering a fluid such as a gas, a liquid, a vapor, or any combination thereof. In some embodiments, the filter is configured for placement in a fluid stream such that the first major membrane surface of the polymeric porous membrane is the most upstream major membrane surface. Stated differently, in some embodiments, the first major membrane surface of the polymeric porous membrane is contacted by the fluid before the second major membrane surface. In other embodiments, the filter is configured for placement in a fluid stream such that the second major membrane surface of the polymeric porous membrane is the most upstream major membrane surface. Stated differently, in some embodiments, the second major membrane surface of the polymeric porous membrane is contacted by the fluid before the first major membrane surface.

The present disclosure describes methods of using the polymeric porous membranes of the present disclosure or filters containing the same. The method includes contacting the polymeric porous membrane or a filter containing the same with a fluid.

In some embodiments, the method 100 of FIG. 7 can be used to form a polymeric porous consistent with the membranes described relative to FIG. 4 and FIG. 5. As such, the present disclosure provides a method for forming a polymer porous membrane, the polymeric porous membrane having a first major membrane surface and a second major membrane surface opposite of the first major membrane surface. The membrane includes a first layer proximate the first major membrane surface. The first layer includes a first plurality of pores having an average pore size. The membrane includes a second layer proximate the second major membrane surface. The second layer includes a second plurality of pores having an average pore size larger than the average pore size of the first plurality of pores. The method includes contacting a casting solution with a substrate to form a cast film having a first major film surface and a second major film surface opposite of the first film major surface. The first film major surface is in contact with the substrate and forming the first major membrane surface, and the second film major surface being a free surface forming the second membrane major surface. The casting solution includes a casting solvent and a polymer dissolved in the casting solvent. The method includes exposing the first film major surface to a cooling temperature that is less than the melting temperature of the casting solvent for a cooling time to form a cooled cast film. The method includes contacting the cooled cast film with a nonsolvent to remove at least a portion of the casting solvent and to form the cast membrane. The nonsolvent is at a nonsolvent temperature that is equal to or greater than the melting temperature of the casting solvent to from the cast membrane.

### Exemplary Embodiments

The following is a non-limiting list of exemplary embodiments according to the present disclosure.

Embodiment A1 is a polymeric porous membrane having a first major membrane surface and a second major membrane surface opposite of the first major membrane surface. The membrane includes a first layer proximate the first major membrane surface, the first layer comprising a first plurality of pores having a first average pore size. The membrane includes a second layer comprising a second plurality of pores having a second average pore size, and the second average pore size being greater than the first average pore size. The membrane includes a third layer proximate the second major membrane surface, the third layer comprising a third plurality of pores having a third average pore size, the third average pore size being smaller than second average pore size.

Embodiment A2 is the polymeric porous membrane of embodiment A1, where the third average pore size is greater than the first average pore size.

Embodiment A3(1) is the polymeric porous membrane of embodiment A1 or A2, wherein the first average pore size of 20 nm to 499 nm.

Embodiment A3(2) is the polymeric porous membrane of embodiment A1 or A2, wherein the first average pore size is 20 nm to 300 nm.

Embodiment A3(3) is the polymeric porous membrane of embodiment A1 or A2, wherein the first average pore size is 20 nm to 250 nm.

Embodiment A3(4) is the polymeric porous membrane of embodiment A1 or A2, wherein the first average pore size is 20 nm to 225 nm.

Embodiment A3(5) is the polymeric porous membrane of embodiment A1 or A2, wherein the first average pore size is 20 nm to 215 nm.

Embodiment A3(6) is the polymeric porous membrane of embodiment A1 or A2, wherein the first average pore size is 20 nm to 200 nm.

Embodiment A3(7) is the polymeric porous membrane of embodiment A1 or A2, wherein the first average pore size is 20 nm to 150 nm.

Embodiment A3(8) is the polymeric porous membrane of embodiment A1 or A2, wherein the first average pore size is 20 nm to 125 nm.

Embodiment A3(9) is the polymeric porous membrane of embodiment A1 or A2, wherein the first average pore size is 20 nm to 115 mm.

Embodiment A3(10) is the polymeric porous membrane of embodiment A1 or A2, wherein the first average pore size is 20 nm to 100 nm.

Embodiment A3(11) is the polymeric porous membrane of embodiment A1 or A2, wherein the first average pore size is 20 nm to 80 nm.

Embodiment A3(12) is the polymeric porous membrane of embodiment A1 or A2, wherein the first average pore size is 100 nm to 250 nm.

Embodiment A3(13) is the polymeric porous membrane of embodiment A1 or A2, wherein the first average pore size is 100 nm to 225 nm.

Embodiment A3(14) is the polymeric porous membrane of embodiment A1 or A2, wherein the first average pore size is 100 nm to 215 nm.

Embodiment A3(15) is the polymeric porous membrane of embodiment A1 or A2, wherein the first average pore size is 100 nm to 200 nm.

Embodiment A3(16) is the polymeric porous membrane of embodiment A1 or A2, wherein the first average pore size is 500 nm to 30000 nm.

Embodiment A4(1) is the polymeric porous membrane of any one of embodiments A1 to A3, where the second average pore size is greater than 3 μm.

Embodiment A4(2) is the polymeric porous membrane of any one of embodiments A1 to A3, where the second average pore size is 10 μm or greater.

Embodiment A4(3) is the polymeric porous membrane of any one of embodiments A1 to A4, where the second average pore size is 500 nm to 3000 nm.

Embodiment A5(1) is the polymeric porous membrane of any one of embodiments A1 to A4, where the third average pore size is 20 nm to 499 nm.

Embodiment A5(2) is the polymeric porous membrane of any one of embodiments A1 to A4, where the third average pore size is 500 nm to 3000 nm.

Embodiment A5(3) is the polymeric porous membrane of any one of embodiments A1 to A4, where the third average pore size is 200 nm to 499 nm.

Embodiment A5(4) is the polymeric porous membrane of any one of embodiments A1 to A4, where the third average pores size is 0.5 μm to 2 μm.

Embodiment A5(5) is the polymeric porous membrane of any one of embodiments A1 to A4, where the third average pore size is 0.5 μm to 1 μm.

Embodiment A6(1) is the polymeric porous membrane of any one of embodiments A1 to A5, where the second average pore size is 3 times or greater than the first average pore size.

Embodiment A6(2) is the polymeric porous membrane of any one of embodiments A1 to A5, where the second average pore size is 5 times or greater than the first average pore size.

Embodiment A6(3) is the polymeric porous membrane of any one of embodiments A1 to A5, where the second average pore size is 10 times or greater than the first average pore size.

Embodiment A7(1) is the polymeric porous membrane of any one of embodiments A1 to A5, where the second average pore size is 3 times or greater than the third average pore size.

Embodiment A7(2) is the polymeric porous membrane of any one of embodiments A1 to A5, where the second average pore size is 5 times or greater than the third average pore size.

Embodiment A7(2) is the polymeric porous membrane of any one of embodiments A1 to A5, where the second average pore size is 10 times or greater than the third average pore size.

Embodiment B1 is a polymeric porous membrane having a first major membrane surface and a second major membrane surface opposite of the first major membrane surface. The membrane includes a first layer proximate the first major membrane surface, the first layer comprising a first plurality of pores having a first average pore size. The membrane includes a second layer comprising a second plurality of pores having a second average pore size, the second average pore size being smaller than the first average pore size. The membrane includes a third layer proximate the second major membrane surface, the third layer comprising a third plurality of pores having a third average pore size, the third average pore size being greater than the second average pore size.

Embodiment B2(1) is the polymeric porous membrane of embodiment B1, where the second average pore size is 20 nm to 499 nm.

Embodiment B2(2) is the polymeric porous membrane of embodiment B1, where the second average pore size is 500 nm to 3000 nm.

Embodiment B2(3) is the polymeric porous membrane of embodiment B1, where the second average pore size is 20 nm to 400 nm.

Embodiment B2(4) is the polymeric porous membrane of embodiment B1, where the second average pore size is 20 nm to 300 nm.

Embodiment B2(5) is the polymeric porous membrane of embodiment B1, where the second average pore size is 20 nm to 250 nm.

Embodiment B2(6) is the polymeric porous membrane of embodiment B1, where the second average pore size is 20 nm to 225 nm.

Embodiment B2(7) is the polymeric porous membrane of embodiment B1, where the second average pore size is 20 nm to 215 nm.

Embodiment B2(8) is the polymeric porous membrane of embodiment B1, where the second average pore size is 20 nm to 200 nm.

Embodiment B2(9) is the polymeric porous membrane of embodiment B1, where the second average pore size is 20 nm to 150 nm.

Embodiment B2(10) is the polymeric porous membrane of embodiment B1, where the second average pore size is 20 nm to 125 nm.

Embodiment B2(11) is the polymeric porous membrane of embodiment B1, where the second average pore size is 20 nm to 115 nm.

Embodiment B2(12) is the polymeric porous membrane of embodiment B1, where the second average pore size is 20 nm to 100 nm.

Embodiment B2(13) is the polymeric porous membrane of embodiment B1, where the second average pore size is 20 nm to 90 nm.

Embodiment B2(14) is the polymeric porous membrane of embodiment B1, where the second average pore size is 20 nm to 80 nm.

Embodiment B2(15) is the polymeric porous membrane of embodiment B1, where the second average pore size is 100 nm to 250 nm.

Embodiment B2(16) is the polymeric porous membrane of embodiment B1, where the second average pore size is 100 nm to 225 nm.

Embodiment B2(17) is the polymeric porous membrane of embodiment B1, where the second average pore size is 100 nm to 215 mm.

Embodiment B2(18) is the polymeric porous membrane of embodiment B1, where the second average pore size is 100 nm to 200 nm.

Embodiment B3(1) is the polymeric porous membrane of embodiment B1 or B2, where the first average pore size is 500 nm to 3000 nm.

Embodiment B3(2) is the polymeric porous membrane of embodiment B1 or B2, where the first average pore size is 20 nm to 500 nm.

Embodiment B3(3) is the polymeric porous membrane of embodiment B1 or B2, where the first average pore size is greater than 3 μm.

Embodiment B3(4) is the polymeric porous membrane of of embodiment B1 or B2, where the first average pore size 200 nm to 499 nm.

Embodiment B3(5) is the polymeric porous membrane of embodiment B1 or B2, where the first average pore size 0.5 μm to 2 μm.

Embodiment B3(6) is the polymeric porous membrane of embodiment B1 or B2, where the first average pore size 0.5 μm to 1 μm.

Embodiment B4(1) is the polymeric porous membrane of embodiment B1 or B2, where the third average pore size is greater than 3 μm.

Embodiment B4(2) is the polymeric porous membrane of any one of embodiments B1 to B3, where the third average pore size is 500 nm to 3000 nm.

Embodiment B4(3) is the polymeric porous membrane of any one of embodiments B1 to B3, where the third average pore size is 20 nm to 500 nm.

Embodiment B4(4) is the polymeric porous membrane of any one of embodiments B1 to B3, where the third average pore size is 200 nm to 499 nm.

Embodiment B4(5) is the polymeric porous membrane of any one of embodiments B1 to B3, where the third average pore size is 0.5 μm to 2 μm.

Embodiment B4(6) is the polymeric porous membrane of any one of embodiments B1 to B3, where the third average pore size is 0.5 μm to 1 μm.

Embodiment C1 is a polymeric porous membrane having a first major membrane surface and a second major membrane surface opposite of the first major membrane surface. The membrane includes a first layer proximate the first major membrane surface, the first layer comprising a first plurality of pores having a first average pore size. The membrane includes a second layer comprising a second plurality of pores having a second average pore size, the second average pore size being larger than the first average pore size.

Embodiment C2(1) is the polymeric porous membrane of embodiment C1, wherein the first average pore size is 20 nm to 500 nm.

Embodiment C2(2) is the polymeric porous membrane of embodiment C1, wherein the first average pore size is 20 nm to 400 nm.

Embodiment C2(3) is the polymeric porous membrane of embodiment C1, wherein the first average pore size is 20 nm to 300 nm.

Embodiment C2(4) is the polymeric porous membrane of embodiment C1, wherein the first average pore size is 20 nm to 250 nm.

Embodiment C2(5) is the polymeric porous membrane of embodiment C1, wherein the first average pore size is 20 nm to 225 nm.

Embodiment C2(6) is the polymeric porous membrane of embodiment C1, wherein the first average pore size is 20 nm to 215 nm.

Embodiment C2(7) is the polymeric porous membrane of embodiment C1, wherein the first average pore size is 20 nm to 200 nm.

Embodiment C2(8) is the polymeric porous membrane of embodiment C1, wherein the first average pore size is 20 nm to 150 nm.

Embodiment C2(9) is the polymeric porous membrane of embodiment C1, wherein the first average pore size is 20 nm to 125 nm.

Embodiment C2(10) is the polymeric porous membrane of embodiment C1, wherein the first average pore size is 20 nm to 115 nm.

Embodiment C2(11) is the polymeric porous membrane of embodiment C1, wherein the first average pore size is 20 nm to 100 nm.

Embodiment C2(12) is the polymeric porous membrane of embodiment C1, wherein the first average pore size is 20 nm to 80 nm.

Embodiment C2(13) is the polymeric porous membrane of embodiment C1, wherein the first average pore size is 100 nm to 250 nm.

Embodiment C2(14) is the polymeric porous membrane of embodiment C1, wherein the first average pore size is 100 nm to 225 nm.

Embodiment C2(15) is the polymeric porous membrane of embodiment C1, wherein the first average pore size is 100 nm to 215 nm.

Embodiment C2(16) is the polymeric porous membrane of embodiment C1, wherein the first average pore size is 100 nm to 200 nm.

Embodiment C3(1) is the polymeric porous membrane of embodiment C1 or C2, where the second average pore size is greater than 3 μm.

Embodiment C3(2) is the polymeric porous membrane of embodiment C1 or C2, where the second average pore size is 10 μm or greater.

Embodiment C3(3) is the polymeric porous membrane of embodiment C1 or C2, where the second average pore size is 500 nm to 3000 nm.

Embodiment C3(4) is the polymeric porous membrane of embodiment C1 or C2, where the second average pore size is 200 nm to 499 nm.

Embodiment C3(5) is the polymeric porous membrane of embodiment C1 or C2, where the second average pore size is 0.5 μm to 2 μm.

Embodiment C3(6) is the polymeric porous membrane of embodiment C1 or C2, where the second average pore size is 0.5 μm to 1 μm.

Embodiment C4(1) is the polymeric porous membrane of any one of embodiments C1 to C3, where the second average pore size is 3 times or greater than the first average pore size.

Embodiment C4(2) is the polymeric porous membrane of any one of embodiments C1 to C3, where the second average pore size is 5 times or greater than the first average pore size.

Embodiment C4(3) is the polymeric porous membrane of any one of embodiments C1 to C3, where the second average pore size is 10 times or greater than the first average pore size.

Embodiment D1(1) is the polymeric porous membrane of any one of embodiments A1 to C4, where the membrane includes poly(vinyl fluoride), poly(ether ketone), sulfonated poly(ether ketone), poly(benzimidazole), poly(ether sulfone), poly(sulfone), cellulose acetate, cellulose tri-acetate, regenerated cellulose, poly(acrylonitrile), poly(methyl acrylate), sulfonated poly(benzimidazole), poly(imide), poly(lactic acid), poly(vinyl alcohol), poly(vinyl chloride), poly(methyl methacrylate), ethylene vinyl alcohol copolymer, poly(L-lactide), poly(DL-lactide), poly(ether ether ketone), sulfonated poly(ether ether ketone), oligodimethylsiloxane-grafted aromatic poly(amide-imide) copolymer, perfluorosulfonated poly(arylene ether sulfone) multiblock copolymer, cyclodextrin polymer, or any combination thereof.

Embodiment D1(2) is the polymeric porous membrane of any one of embodiments A1 to C4, where the membrane includes poly(vinylidene fluoride), poly(ether sulfone), cellulose acetate, or cellulose tri-acetate, or any combination thereof.

Embodiment D1(3) is the polymeric porous membrane of any one of embodiments A1 to C4, where the membrane includes poly(vinylidene fluoride), poly(ether sulfone), cellulose acetate, or cellulose tri-acetate, or any combination thereof.

Embodiment D1(4) is the polymeric porous membrane of any one of embodiments A1 to C4, where the membrane includes poly(vinylidene fluoride), poly(ether sulfone), or both.

Embodiment D1(5) is the polymeric porous membrane of any one of embodiments A1 to C4, where the membrane includes cellulose acetate, cellulose tri-acetate, or both.

Embodiment D1(6) is the polymeric porous membrane of any one of embodiments A1 to (4, where the membrane includes poly(vinylidene fluoride).

Embodiment D1(7) is the polymeric porous membrane of any one of embodiments A1 to C4, where the membrane includes poly(ether sulfone).

Embodiment D1(8) is the polymeric porous membrane of any one of embodiments A1 to C4, where the membrane includes cellulose acetate.

Embodiment D1(9) is the polymeric porous membrane of any one of embodiments A1 to C4, where the membrane includes cellulose tri-acetate

Embodiment D2 is the polymeric porous membrane of any one of embodiments A1 to C4, where the polymeric porous membrane includes a semi-crystalline polymer.

Embodiment D3 is the polymeric porous membrane of embodiment D2, where the semi-crystalline polymer includes ethylene vinyl alcohol copolymer, poly(vinylidene fluoride); poly(ether ketone); ethylene vinyl alcohol copolymer; poly(ether ether ketone); cellulose; or any combination thereof.

Embodiment D4 is the polymeric porous membrane of any one or embodiments A1 to C4, the polymeric porous membrane includes an amorphous polymer.

Embodiment D5 is the polymeric porous membrane of embodiment D4, where the amorphous polymer includes poly(benzimidazole), poly(sulfone); poly(ether-sulfone); cellulose acetate; poly(imide); poly(vinyl chloride); poly(methyl methacrylate).

Embodiment D6(1) is the polymeric porous membrane of any one or embodiments A1 to D5, where the membrane has a clean water permeance (CWP) of 100 L m⁻² h−1bar⁻¹ or greater.

Embodiment D6(2) is the polymeric porous membrane of any one or embodiments A1 to D5, where the membrane has a CWP of 25 L m⁻²h⁻¹bar⁻¹ to 1200 L m⁻²h⁻¹bar⁻¹.

Embodiment D6(3) is the polymeric porous membrane of any one or embodiments A1 to D5, where the membrane has a CWP of 50 L m⁻²h⁻¹bar⁻¹ to 1100 L m⁻²h⁻¹bar⁻¹.

Embodiment D6(4) is the polymeric porous membrane of any one or embodiments A1 to D5, where the membrane has a CWP of 60 L m⁻²h⁻¹bar⁻¹ to 1000 L m⁻²h⁻¹bar⁻¹.

Embodiment D6(5) is the polymeric porous membrane of any one or embodiments A1 to D5, where the membrane has a CWP of 50 L m⁻²h⁻¹bar⁻¹ to 1000 L m⁻²h⁻¹bar⁻¹.

Embodiment D6(6) is the polymeric porous membrane of any one or embodiments A1 to D5, where the membrane has a CWP of 4000 L m⁻²h⁻¹bar⁻¹ to 15000 L m⁻²h⁻¹bar⁻¹.

Embodiment D6(7) is the polymeric porous membrane of any one or embodiments A1 to D5, where the membrane has a CWP of 4000 L m⁻²h⁻¹bar⁻¹ to 12000 L m⁻²h⁻¹bar⁻¹.

Embodiment D6(8) is the polymeric porous membrane of any one or embodiments A1 to D5, where the membrane has a CWP of 5000 L m⁻²h⁻¹bar⁻¹ to 12000 L m⁻²h bar′.

Embodiment D6(9) is the polymeric porous membrane of any one or embodiments A1 to D5, where the membrane has a CWP of 25 L m⁻²h⁻¹bar⁻¹ to 1200 L m⁻²h⁻¹bar⁻¹ or 4000 L m⁻²h⁻¹bar⁻¹ to 15000 L m⁻²h⁻¹bar⁻¹.

Embodiment D7(1) is the polymeric porous membrane of any one or embodiments A1 to D6, where the membrane has a thickness of 0.005 mm to 1 mm.

Embodiment D7(2) is the polymeric porous membrane of any one or embodiments A1 to D6, where the membrane has a thickness of 0.005 mm to 0.9 mm.

Embodiment D7(3) is the polymeric porous membrane of any one or embodiments A1 to D6, where the membrane has a thickness of 0.005 mm to 0.8 mm.

Embodiment D7(4) is the polymeric porous membrane of any one or embodiments A1 to D6, where the membrane has a thickness of 0.005 mm to 0.7 mm.

Embodiment D7 (S) is the polymeric porous membrane of any one or embodiments A1 to D6, where the membrane has a thickness of 0.005 mm to 0.6 mm.

Embodiment D7(6) is the polymeric porous membrane of any one or embodiments A1 to D6, where the membrane has a thickness of 0.005 mm to 0.5 mm.

Embodiment D7(7) is the polymeric porous membrane of any one or embodiments A1 to D6, where the membrane has a thickness of 0.005 mm to 0.4 mm.

Embodiment D7(8) is the polymeric porous membrane of any one or embodiments A1 to D6, where the membrane has a thickness of 0.005 mm to 0.3 mm.

Embodiment D7(9) is the polymeric porous membrane of any one or embodiments A1 to D6, where the membrane has a thickness of 0.005 mm to 0.2 mm.

Embodiment D7(10) is the polymeric porous membrane of any one or embodiments A1 to D6, where the membrane has a thickness of 0.005 mm to 0.1 mm.

Embodiment D8 is the polymeric porous membrane of any one of embodiments A1 to D7 where at least one of the plurality of pores has a channel morphology.

Embodiment E1 is a filter that includes the polymeric porous membrane of any one of embodiments A1 to D8.

Embodiment E2 is the filter of embodiment E1, where the filter is configured and arranged for placement in a fluid stream with the first membrane major surface being the most upstream layer.

Embodiment E3 is the filter of embodiment E1, where the filter is configured and arranged for placement in a fluid stream with the second membrane major surface being the most upstream layer.

Embodiment F1 is a method of forming the polymeric porous membrane of any one of embodiments A1 to D8. The method includes contacting a casting solution with a substrate to form a cast film having a first major film surface and a second major film surface opposite of the first film major surface. The first film major surface is in contact with the substrate and forming the first major membrane surface, and the second film major surface being a free surface forming the second membrane major surface. The casting solution includes a casting solvent and a polymer dissolved in the casting solvent. The method includes exposing the first film major surface to a cooling temperature that is less than the melting temperature of the casting solvent for a cooling time to form a cooled cast film. The method includes contacting the cooled cast film with a nonsolvent to remove at least a portion of the casting solvent and to form the cast membrane. The nonsolvent is at a nonsolvent temperature that is equal to or greater than the melting temperature of the casting solvent to from the cast membrane.

Embodiment G1 is a polymeric porous membrane formed from a method. The polymeric porous membrane having a first major membrane surface and a second major membrane surface opposite of the first major membrane surface. The membrane includes a first layer proximate the first major membrane surface. The first layer includes a first plurality of pores having an average first pore size. The membrane includes a second layer proximate the second major membrane surface. The second layer includes a second plurality of pores having a second average pore size, the second average pore size being larger than first average pore size. The method includes contacting a casting solution with a substrate to form a cast film having a first major film surface and a second major film surface opposite of the first filmi major surface. The first film major surface is in contact with the substrate and forming the first major membrane surface, and the second film major surface being a free surface forming the second membrane major surface. The casting solution includes a casting solvent and a polymer dissolved in the casting solvent. The method includes exposing the first film major surface to a cooling temperature that is less than the melting temperature of the casting solvent for a cooling time to form a cooled cast film. The method includes contacting the cooled cast film with a nonsolvent to remove at least a portion of the casting solvent and to form the cast membrane. The nonsolvent is at a nonsolvent temperature that is equal to or greater than the melting temperature of the casting solvent to from the cast membrane.

Embodiment G2 is method of embodiment G1, wherein the polymeric porous membrane formed from the method is the polymeric porous membrane of any one of embodiments C1 to C4 or D1 to D8 (as dependent on any one of embodiments C1 to C4).

Embodiment G3(1) is the method of embodiment G1 or G2, where the cooling temperature is 20° C. or greater below the melting temperature of the casting solvent.

Embodiment G3(2) is the method of embodiment G1 or G2, where the cooling temperature is 30° C. or greater below the melting temperature of the casting solvent.

Embodiment G3(3) is the method of embodiment G1 or G2, where the cooling temperature is 40° C. or greater below the melting temperature of the casting solvent.

Embodiment G3(4) is the method of embodiment G1 or G2, where the cooling temperature is 50° C. or greater below the melting temperature of the casting solvent.

Embodiment G3(5) is the method of embodiment G1 or G2, where the cooling temperature is 60° C. or greater below the melting temperature of the casting solvent.

Embodiment G3(6) is the method of embodiment G1 or G2, where the cooling temperature is 70° C. or greater below the melting temperature of the casting solvent.

Embodiment G3(7) is the method of embodiment G1 or G2, where the cooling temperature is 40° C. to 90° C. below the melting temperature of the casting solvent.

Embodiment G3(8) is the method embodiment G1 or G2, where the cooling temperature is 50° C. to 80° C. below the melting temperature of the casting solvent.

Embodiment G3(9) is the method of embodiment G1 or G2, where the cooling temperature is −180° C. to 50° C.

Embodiment G3(10) is the method of embodiment G1 or G2, where the cooling temperature is −80° C. to −10° C.

Embodiment G3(11) is the method of embodiment G1 or G2. where the cooling temperature is −60° C. to −30° C.

Embodiment G3(12) is the method of embodiment G1 or G2, where the cooling temperature is −80° C. to −10° C. or −60° C. to −30° C.

Embodiment G4(1) is the method of any one of embodiments G1 to G3, where the melting temperature of the casting solvent is −110° C. to 80° C.

Embodiment G4(2) is the method of any one of embodiments G1 to G3, where the melting temperature of the casting solvent is 0° C. to 30° C.

Embodiment G4(3) is the method of any one of embodiments G1 to G3, where the melting temperature of the casting solvent is 0° C. to 25° C.

Embodiment G4(4) is the method of any one of embodiments G1 to G3, where the melting temperature of the casting solvent is 0° C. to 20° C.

Embodiment G4(5) is the method of any one of embodiments G1 to G3, where the melting temperature of the casting solvent is 5° C. to 20° C.

Embodiment G4(6) is the method of any one of embodiments G1 to G5, where the melting temperature of the casting solvent is 50° C. to 80° C.

Embodiment G4(7) is the method of any one of embodiments G1 to G3, where the melting temperature of the casting solvent is 60° C. to 80° C.

Embodiment G4(8) is the method of any one of embodiments G1 to G3, where the melting temperature of the casting solvent is 60° C. to 70° C.

Embodiment G4(9) is the method of any one of embodiments G1 to G3, where the melting temperature of the casting solvent is 65° C. to 75° C.

Embodiment G4(10) is the method of any one of embodiments G1 to G3, where the melting temperature of the casting solvent is 0° C. to −50° C.

Embodiment G4(11) is the method of any one of embodiments G1 to G3, where the melting temperature of the casting solvent is −10° C. to −50° C.

Embodiment G4(12) is the method of any one of embodiments G1 to G3, where the melting temperature of the casting solvent is −10° C. to −40° C.

Embodiment G4(13) is the method of any one of embodiments G1 to G3, where the melting temperature of the casting solvent is −10° C. to −30° C.

Embodiment G4(14) is the method of any one of embodiments G1 to G3, where the melting temperature of the casting solvent is −10° C. to −20° C.

Embodiment G4(15) is the method of any one of embodiments G1 to G3, where the melting temperature of the casting solvent is −20° C. to −60° C.

Embodiment G4(16) is the method of any one of embodiments G1 to G3, where the melting temperature of the casting solvent is 5° C. to 20° C., 65° C. to 75° C., −10° C. to −20° C., or −40° C. to −50° C.

Embodiment G5(1) is the method of any one of embodiments G1 to G4, where the melting temperature of the casting solvent is −30° C. to −60° C.

Embodiment G5(1) is the method of any one of embodiments G1 to G4, where the melting temperature of the casting solvent is −40° C. to −50° C.

Embodiment G6 is the method of any one of embodiments G1 to G5, where the nonsolvent temperature is 1° C. or greater, 1° C. or greater, or 5° C. or greater above the melting temperature of the casting solvent.

Embodiment G7(1) is the method of any one of embodiments G1 to G6, where the casting solvent includes acetic acid, acetone, acetonitrile, t-butyl alcohol, caprolactam, cyclohexane, dimethylacetamide, dimethylformamide, dimethyl sulfoxide, dioxane, ethyl lactate, glycerin, methylsulfonylmethane, N-methyl pyrrolidone, gamma-valerolactone, valerolactam, caprolactone, caprolactam, hexamethylphosphoroamide, glycerol, sulfolane, tetrahydrofuran, gamma botyrolactone, dimethyl imidazolidine, or any combination thereof.

Embodiment G7(2) is the method of any one of embodiments G1 to G6, where the casting solvent includes dimethyl sulfoxide, caprolactam, N-methyl pyrrolidone, gamma butyrolactone, or any combination thereof.

Embodiment G7(3) is the method of any one of embodiments G1 to G6, where the casting solvent includes dimethyl sulfoxide.

Embodiment G7(4) is the method of any one of embodiments G1 to G6, where the casting solvent includes caprolactam.

Embodiment G7(5) is the method of any one of embodiments G1 to G6, where the casting solvent includes N-methyl pyrrolidone.

Embodiment G7(6) is the method of any one of embodiments G1 to G6, where the casting solvent includes gamma butyrolactone.

Embodiment G7(7) is the method of any one of embodiments G1 to G6, where the casting solution is free of water.

Embodiment G8(1) is the method of any one of embodiments G1 to G7, where the nonsolvent includes water, glycerol, t-butanol, sulfolane, or any combination thereof.

Embodiment G8(2) is the method of any one of embodiments G1 to G7, where the nonsolvent includes water.

Embodiment G9 is the method of any one of embodiments G1 to G8, where the casting solvent includes dimethyl sulfoxide and the nonsolvent includes water.

Embodiment G10 is the method of any one of embodiments G1 to G9, where the casting solution further includes an additive.

Embodiment G11 is the method of embodiment G10, where the additive includes a poly(alkylene glycol), an alkoxylated poly(alkylene glycol), polyvinyl pyrrolidine, or any combination thereof.

Embodiment G12(1) is the method of any one of embodiments G1 to G11, where the casting solution includes 5 wt-% to 45 wt-% of the polymer.

Embodiment G12(2) is the method of any one of embodiments G1 to G11, where the casting solution includes 10 wt-% to 30 wt-% of the polymer.

Embodiment G12(3) is the method of any one of embodiments G1 to G11, where the casting solution includes 5 wt-% to 30 wt-% of the polymer.

Embodiment G12(4) is the method of any one of embodiments G1 to G11, where the casting solution includes 10 wt-% to 25 wt-% of the polymer.

Embodiment G13 is the method of any one of embodiments G1 to G12, wherein the polymer includes any polymer of embodiments D1 to D5.

### Examples

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight. The following abbreviations may be used in the following examples and/or other places in this disclosure: Mn=number average molecular weight; Mw=weight average molecular weight; mL=milliliter; L=liter; LPM=liters per minute; m=meter, mm=millimeter, min=minutes; s=seconds; cm=centimeter; μm=micrometer; nm=nanometer; kg=kilogram, g=gram, min=minute, s=second, h=hour, ° C.=degrees Celsius, ° F.=degrees Fahrenheit; wt-%=weight percent; M=molar; μM=micromole; mM=millimolar; DI water=deionized water; L m⁻² h⁻¹=liters per meters squared per hour; and L m⁻²h⁻¹bar⁻¹=liters per meters squared per hour per bar.

### Test Methods:

### Gas Liquid Porometry Test Method:

The average pore size of a selective layer can be measured using gas liquid porometry. The gas liquid porometry method is based on the measurement of the gas pressure used to flush a wetting liquid out of the liquid-filled porous membrane. As the pressure of gas increases, the applied pressure overcomes the surface tension of the wetting liquid in the pore neck and flushes the wetting liquid out of the pore. The pressure used to push out the wetting liquid can be correlated to the average pore size using the Washburn equation.

First, the porous membrane was spontaneously wetted with a liquid of a relatively low surface tension (for example, a fluorocarbon such as POREFIL available from Aptco Technologies NV, Belgium). The wetted membrane was placed in the measuring compartment and subjected to dry air with increasing pressure steps. This resulted in a ‘wet curve’ which represented the measured gas flow through the sample against the applied dry air pressure (inversely proportional to the pore size). Afterwards, a ‘dry curve’ was obtained from similar pressure steps on the dry membrane and was used as a reference. The portions of plot of wet curve from the point where the first flow of gas is observed up to the point where it meets the dry run plot are used for determining the pore-neck size distributions. The maximum and the minimum neck pore sizes were determined by the bubble point (pressure at which the first flow of gas across wet membrane was observed) and from the pressure where wet and dry curves converged, respectively. The mean flow pore size was calculated from the pressure at which the wet flow is half of the dry flow. The mean flow pore size is the pressure where 50% of the flow gets through the pores during the test, which is then recalculated to a mean pore size. The mean pore size can be considered the average pore size if the distribution is a normal distribution (on a linear or log scale). Commonly the distribution is a normal distribution for selective layers.

### Image Analysis Average Pore Size Test Method:

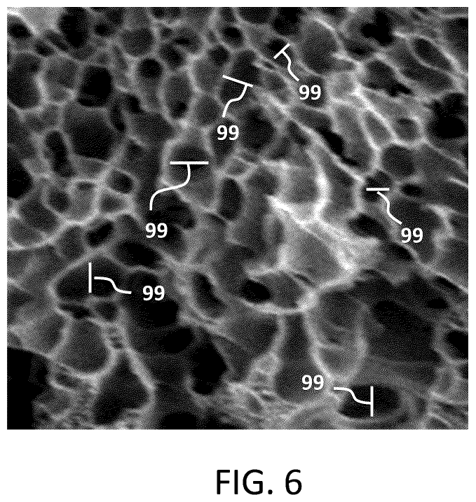

The pore size of a pore in a layer that is not the selective layer can be measured by analyzing a cross-sectional image of the polymeric porous membrane. In a cross-sectional image of polymeric porous membrane, a pore may appear as two-dimensional shape (for example, ovals, circles, amorphous shapes, channels, and the like). Each two-dimensional shape has a major axis and a minor axis. The pore size is measured as minor axis of the pore. FIG. 6 is a cross-sectional scanning electron micrograph of a porous polymeric membrane where the location of some pore size measurements may be taken (99, white bars). The average pore size can be calculated as the number average of at least 30 measured pores.

### Pore Size Distribution Test Method

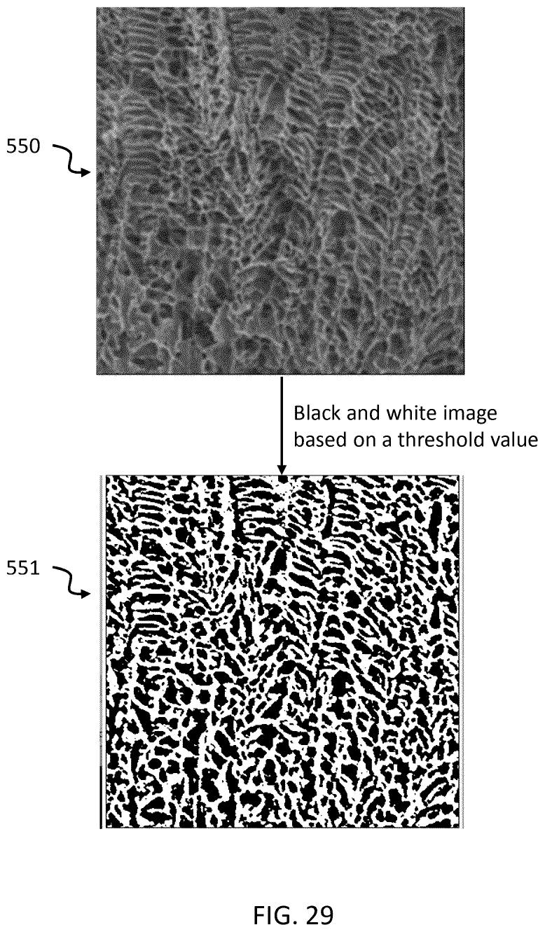

The degree of porosity through a cross-section of a porous polymeric membrane can be done through Image Analysis. The distinction between pores and polymer material in a porous polymeric membrane can be done by creating a black and white image (551 in FIG. 29) of a greyscale SEM cross-section image (550 in FIG. 29) of a polymeric porous membrane based on a proper threshold value (see FIG. 29). The black and white images can be analyzed by using classical Image Analysis blobbing algorithms to determine the pore size and pore density throughout the cross-sectional sample. Based on this data, the distribution curves can be calculated.

### Example 1: Formation and Analysis of Poly(Vinyl Pyrrolidone) and Poly(Ether Sulfone) Membranes

Various poly(vinyl pyrrolidone) (PVDF) and poly(ether sulfone) (PES) porous membranes were made and characterized. Briefly, a casting solution of PVDF (Mw=440 kDa) or PES (Mw=72 kDa) and dimethyl sulfoxide (DMSO) was deposited onto an aluminum substrate. The aluminum substrate was chilled to a cooling temperature. The cast film was exposed to the cooling temperature for a cooling time. Following the cooling time, the cooled cast film was submerged in a water bath (nonsolvent) at a temperature between 3° C. and 22° C.

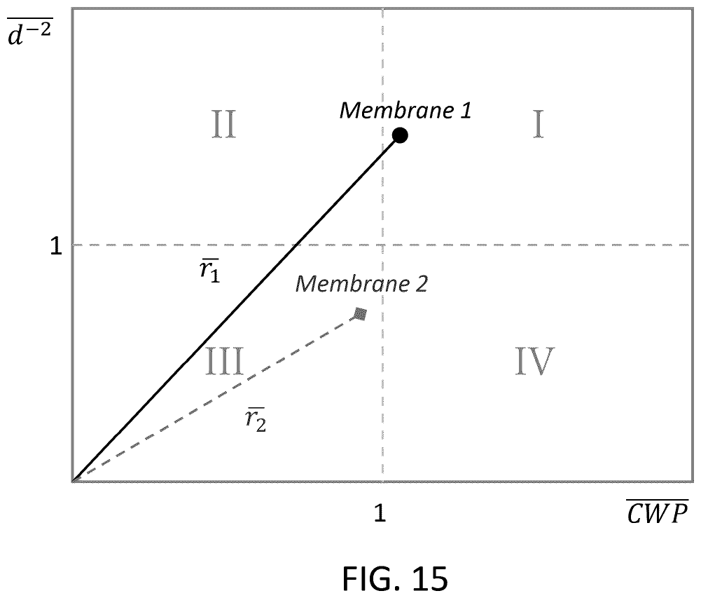

The impact of the amount of PVDF in the casting solution, the cooling temperature (T_{cooling}), and the cooling time (tₘᵢₙ) on the membrane average pore size of the selective layer and the clean water permeance (CWP) were explored. Trends in membrane performance were observed from changing the variables and compared using a membrane performance plot (FIG. 15). The underlying conceptual model of the membrane performance plot is that a membrane for a particular application may ideally have a pore size just smaller than the solute of interest (the component of a fluid stream for which removal is desired), a maximized number of pores, a tortuosity of 1 across the membrane, and an infinitesimally small selective layer thickness. When combined, these properties may translate into a high retention of the solute of interest and high permeance. Permeance and retention are inversely proportional to each other, and retention is dependent at least in part on the solute which needs to be retained and therefore may be different for each application. This makes it difficult to compare membrane performance across different membranes. In order to make an objective comparison regardless of application, the retention (approximated by the inverse of the average pore diameter (d⁻²; average pore size of the selective layer) is plotted as a function of permeance (clean water permeance (CWP)). To give permeance and inverse pore size the same weight, the values are normalized by dividing them by the average of all commercial PVDF-porous membranes (Table 1) or to that of commercial PES-membranes (Error! Reference source not found.). When the normalized values are plotted on the membrane performance plot, the radial distance from the origin (“r̅”) is directly proportional to the membrane performance. A large distance means that a better selectivity is reached without compromising for the permeance and vice versa. The radial distance from the origin defined as:

$$\overline{r} = \sqrt{{( \overline{{d}^{- 2}} )}^{2} + {\overline{CWP}}^{2}} .$$

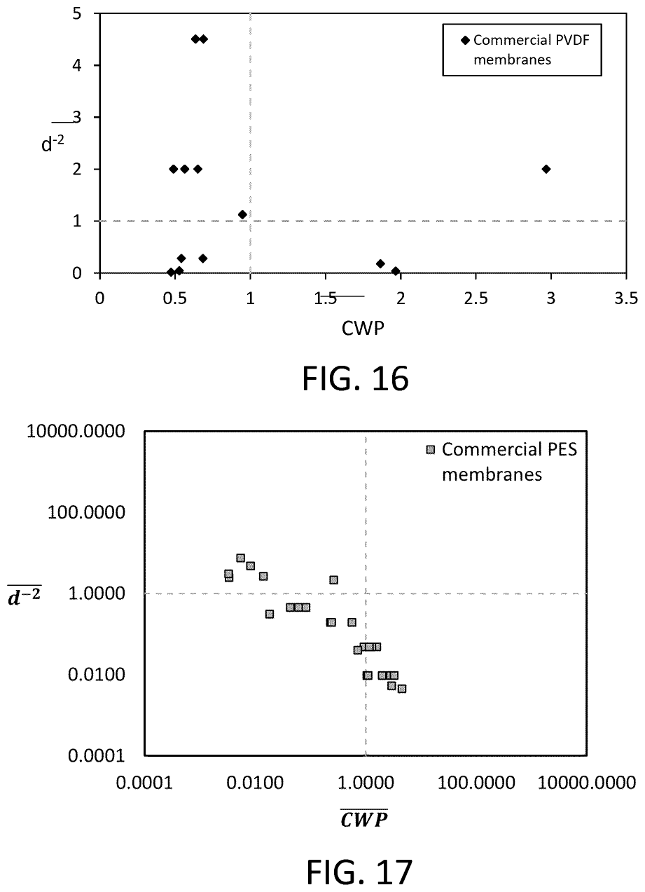

FIG. 16 shows a normalized membrane performance plot for commercial PVDF membranes shown in Table 1. The pore size is the average pore size of the selective layer of the commercial membrane. The inverse pore size is the inverse of the average pore size of the selective layer of the commercial membrane. The TRISEP UB70 had the best performance (greatest radial distance from the origin).

TABLE 1
Properties of various commercial PVDF membranes

| | | | Inverse | |
|---|---|---|---|---|
| | | Pore size | pore size | CWP |
| Membrane | Supplier (Location) | (nm) | (nm⁻¹) | (L m⁻² h⁻¹ bar⁻¹) |
| UB70 | TRISEP (Goleta, CA) | 30 | 0.033 | 394.5 |
| JX | SUEZ GE (Paris, France) | 300 | 0.003 | 62.8 |
| ZEEWEED | SUEX (Paris, France) | 20 | 0.050 | 91.5 |
| 1000 | | | | |
| ZEEWEED | SUEZ (Paris, France) | 20 | 0.050 | 84.5 |
| 1500 | | | | |
| V0.1 | SYNDER Filtration (Vacaville, | 100 | 0.010 | 247.9 |
| | CA) | | | |
| V0.2 | SYNDER Filtration (Vacaville, | 220 | 0.005 | 261.3 |
| | CA) | | | |
| MV020 | MYCRODYN NADIR | 200 | 0.005 | 70.1 |
| | (Wiesbaden, Germany) | | | |
| INEGRAPAC | DOW-DUPONT (Wilmington, DE) | 30 | 0.033 | 65 |
| INEGRA | DOW-DUPONT (Wilmington, DE) | 30 | 0.033 | 75 |
| FLUX | | | | |
| HYDRACAP | HYDRONAUTICS (Oceanside, | 80 | 0.013 | 72 |
| MAX | CA) | | | |
| PURON | KOCH Industries (Wichita, KS) | 30 | 0.033 | 86.5 |
| ENVIQ | QUA (San Diego, CA) | 40 | 0.025 | 126 |
| MEMBRAY | TORAY (Tokyo, Japan) | 80 | 0.013 | 91 |

| | | |
|---|---|---|
| Average | 0.024 | 133 |

FIG. 17 shows a normalized membrane performance plot for commercial PES membranes shown in Table 2. The pore size is the average pore size of the selective layer of the commercial membrane. The inverse pore size is the inverse of the average pore size of the selective layer of the commercial membrane.

TABLE 2
Properties of various commercial PES membranes

| | | Pore | Inverse pore | |
|---|---|---|---|---|
| | | size | size squared | CWP |
| Membrane | Supplier | (nm) | (nm⁻²) | (L m⁻² h⁻¹ bar⁻¹) |
| QUA membrane 1 | QUA (San Diego, CA) | 20 | 0.0025 | 50-150 |
| HYDRACP | HYDRANAUTICS | 25 | 0.0016 | 15-60 |
| | (Oceanside, CA) | | | |
| STERLITECH | STERLITECH | 30 | 0.0011 | 4,800 |
| membrane 1 | (Aubum, WA) | | | |
| STERLITECH | | 100 | 0.0001 | 10,200 |
| membrane 2 | | | | |
| STERLITECH | | 200 | 0.000025 | 28,900 |
| membrane 3 | | | | |
| STERLITECH | | 450 | 0.000005 | 50,650 |
| membrane 4 | | | | |
| STERLITECH | | 650 | 0.000002 | 83,100 |
| membrane 5 | | | | |
| SATORIUS | SATORIUS | 28 | 0.0013 | 61 |
| membrane 1 | (Gottingen, Germany) | | | |
| SATORIUS | | 65 | 0.0002 | 789 |
| membrane 2 | | | | |
| SATORIUS | | 100 | 0.0001 | 4,200 |
| membrane 3 | | | | |
| SATORIUS | | 200 | 0.000025 | 16,800 |
| membrane 4 | | | | |
| SATORIUS | | 450 | 0.000005 | 19,200 |
| 5 | | | | |
| | PALL (Port | 16 | 0.0039 | 100 |
| PALL membrane 2 | Washington, NY) | 80 | 0.00016 | 329 |
| PALL membrane 3 | | 100 | 0.0001 | 2,440-6,440 |
| PALL membrane 4 | | 200 | 0.000025 | 16,800-30,100 |
| PALL membrane 5 | | 450 | 0.000005 | 33,100-87,000 |
| MILLPORE | MILLIPORE | 27 | 0.0014 | 255 |
| membrane 1 | (Burlington, MA) | | | |
| MILLPORE | | 65 | 0.00024 | 1504 |
| membrane 2 | | | | |
| MILLPORE | | 220 | 0.000021 | 13,000 |
| membrane 3 | | | | |
| MILLPORE | | 450 | 0.000005 | 20,000 |
| membrane 4 | | | | |
| | | Average | 0.000523 | 18,166 |

### Example 1a. Impact of PES or PVDF Casting Solution Concentration

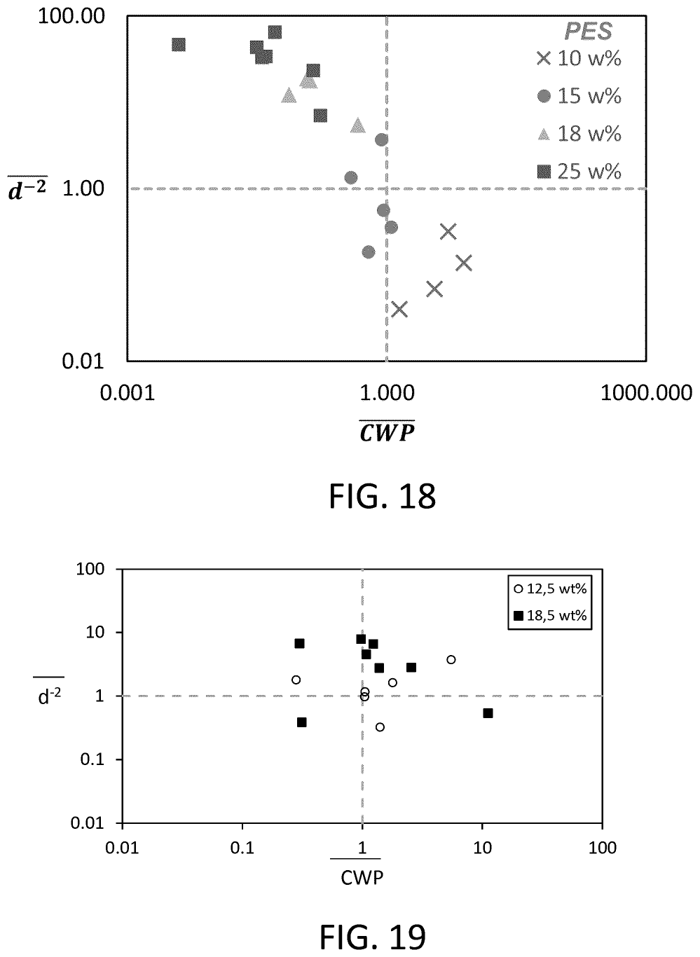

The impact of the concentration of PES or PVDF in the casting solution was assessed. PES membranes were prepared from a casting solution of DMSO and 10 wt-% (w %) PES, 15 wt-% PES, 18 wt-% PES, or 25 wt-% PES. PVDF membranes were prepared from a casting solution of DMA and 12.5 wt-% (w %) PVDF or 18 wt-% PVDF. The cooling temperature was −50° C., the nonsolvent was water at 3° C. and 22° C., and the cooling time was 30 s to 360 s. FIG. 18 and FIG. 19 show the membrane performance plots for the PES membranes and PVDF membranes, respectively.

For PES membranes, it was observed that an increase in PES concentration in the casting solution resulted in an enhancement in selectivity, accompanied by a reduction in permeability (FIG. 18). This change in performance was evident as the polymer concentration increased from 10 wt-% to 25 wt-%, resulting in a shift of performance from quadrant IV to quadrant II on the membrane performance plot. For the experimental outcomes demonstrated the ability to fabricate a diverse range of membrane grades while maintaining the desired characteristic of a narrow pore size distribution, by adjusting the processing conditions such as the cooling temperature, cooling time, casting solution thickness, nonsolvent temperature, or any combination thereof. For the 10 wt % PES membranes, an average pore size of the selective layer (mean flow pore sizes) from 700 nm to 2400 μm was obtained. For the 15 wt-% PES membranes, the average pore size of the selective layer (mean flow pore sizes) ranged from 320 nm to 1490 nm. For the 25 wt-% PES membranes, the average pore size of the selective layer (mean flow pore sizes) ranged from 56 nm to 250 nm.

For the PVDF membranes, the results indicate in general that higher polymer concentrations result in higher selectivities (FIG. 19). However, the trend was not as clear as it was for the PES membranes. As such, it is thought that other process parameters influence the membrane performance. For example, for all tested polymer concentrations, membranes with high flux and low selectivity as well as membranes with high selectivity and low flux were obtained (FIG. 19). Different membrane grades could be prepared from the same composition, although the difference was less pronounced than with the PES membranes. For the 12.5 wt % PVDF membranes, the average pore size of the selective layer (mean flow pore sizes) of 150 nm to 400 nm was obtained. For the 18.5 wt-% PVDF membranes, the average pore size of the selective layer (mean flow pore sizes) 100 nm to 250 nm.

### Example 1b. Impact of Membrane Thickness on Performance

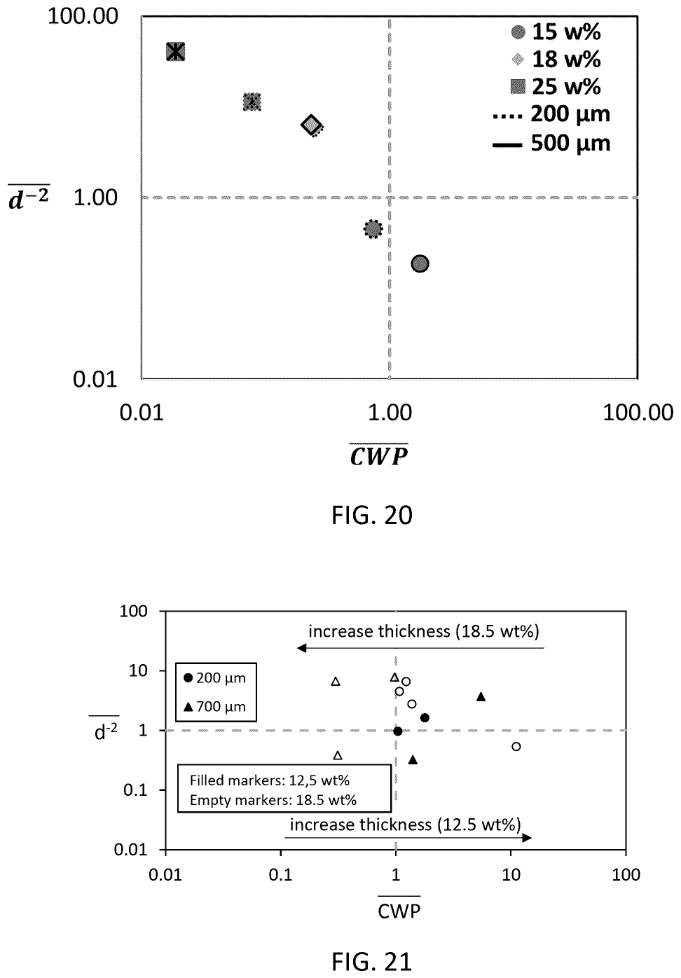

The impact of the thickness of the PES membranes and PVDF membranes in Example 1a on performance was evaluated. The PES membranes and the PVDF membranes were cast to have a membrane thickness of 200 μm or 500 μm. FIG. 20 and FIG. 21 show the membrane performance plots for the PES membranes and PVDF membranes, respectively.

Results from the PES membranes indicate the presence of an interaction between the thickness of the membrane and the concentration of the polymer (FIG. 20). Specifically, at a relatively lower polymer concentration of 15 wt-%, increasing the thickness resulted in a decrease in selectivity and an increase in permeability. Conversely, for the 25 wt-% solution, increasing the thickness led to a decrease in selectivity and an increase in permeability. However, for the 18 wt-% concentration, varying the thickness did not yield any discernible changes in performance. These findings highlight the complex relationship between membrane thickness, polymer concentration, and the resulting performance characteristics.

Similar results to the PES membranes were observed for the PVDF membranes (FIG. 21). However, unlike with the PES membranes, the link between casting thickness and selectivity is less apparent and both membranes with high and low selectivity are found regardless of the thickness.

### Example 1c. Impact of the Cooling Temperature on Membrane Performance

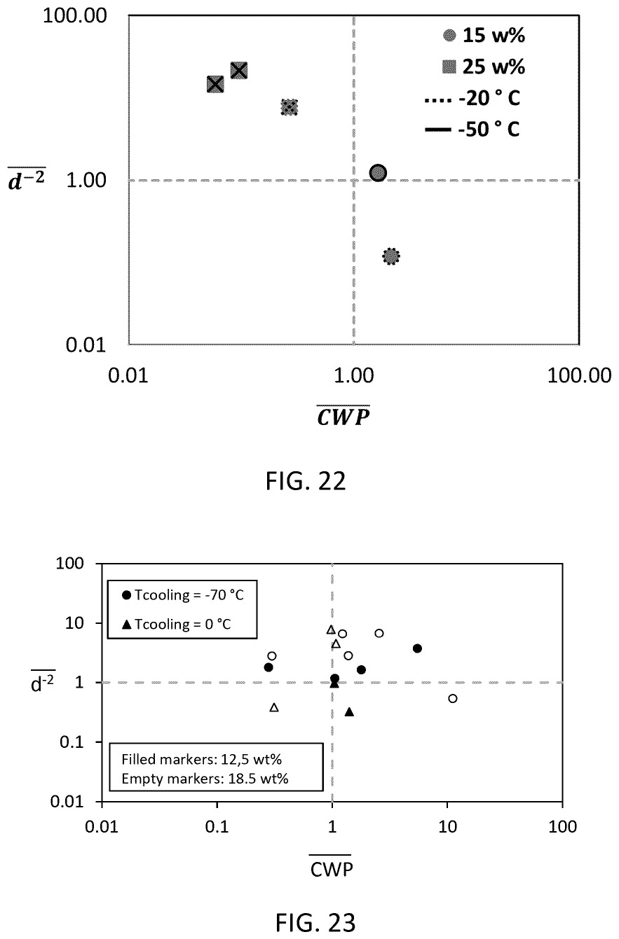

The impact of the cooling temperature was assessed. PES membranes were prepared from a casting solution of DMSO and 15 wt-% PES or 25 wt-% PES. PVDF membranes were prepared from a casting solution of DMA and 12.5 wt-% (w %) PVDF or 18 wt-% PVDF. The cooling temperature for the PES systems was either −20° C. or −50° C. The cooling temperature for the PVDF systems was either 0° C. or −70° C. For both polymers, the nonsolvent was water 15° C. and 20° C. and the cooling time was 30 s to 80 s. FIG. 22 and FIG. 23 show the membrane performance plots for the PES membranes and PVDF membranes, respectively.

PES membranes showed a drop in both selectivity and permeability with increasing the cooling plate temperature, regardless of the polymer concentration in the casting solution (FIG. 22). It was observed that the trend observed for the lower polymer concentration is steeper than that for the higher polymer concentration. Since the effect of the plate temperature on the selectivity may be influenced by the longer time permitted for nuclei to grow, it is possible that at a lower PES concentration (lower viscosity), the kinetics of nuclei growth increases. Accordingly, the increase in average pore size of the selective layer of the 15 wt-% PES concentration at the −50° C. to the −20° C. cooling temperature was more significant when compared to the 25 wt-% PES concentration.

For the PVDF membranes, an overall better performance was found when a lower cooling temperature was used (a higher temperature gradient). Table 3 shows the distance from the origin of each sample in FIG. 23. At a cooling plate temperature of −70° C., in general, higher selectivities were observed. Surprisingly, for the samples that were investigated, this occurs with very little compromise on the flux (see Table 3 and FIG. 23). For both polymer concentrations, the average flux is higher for the membrane prepared at a cooling temperature of −70° C.

TABLE 3
Distance from the origin of the performance plot of FIG. 22

| | Distance from origin |
|---|---|
| Sample group | (performance plot) |
| 12.5 wt % PVDF/T_{cooling} = 0° C. | 1.43 |
| 12.5 wt % PVDF/T_{cooling} = −70° C. | 3.11 |
| 18.5 wt % PVDF/T_{cooling} = 0° C. | 4.35 |
| 18.5 wt % PVDF/T_{cooling} = −70° C. | 6.30 |

### Example 1c. Impact of the Cooling Time on Membrane Performance

The impact of the cooling time was assessed. PES membranes were prepared from a casting solution of DMSO and 15 wt-% PES or 25 wt-% PES. PVDF membranes were prepared from a casting solution of DMSO and 12.5 wt-% (w %) PVDF or 18 wt-% PVDF. For the PES systems, the cooling temperature was −50° C. time, the nonsolvent was water (7° C. to 20° C.) and the cooling time was either was either 0 s, 0 to 30 s, or greater than 30 s. For the PVDF systems, the cooling temperature was 0° C. or −70° C., the nonsolvent was water (10° C.), and the cooling time was either 10 s or 120 s.

FIG. 24 cross-sectional images of the PES membranes formed. Without a cooling step (cooling time=0), the PES membrane had a conventional NIPS cross-sectional morphology. At a cooling time of 0 to 30 s, a morphology that included large pores and small pores was observed. At a cooling time of greater than 30 s, small pores and channel pores were observed.

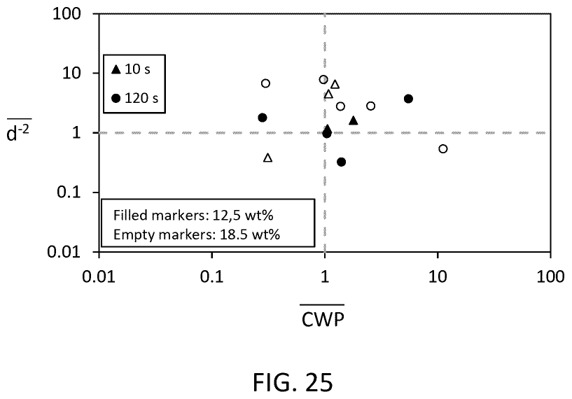

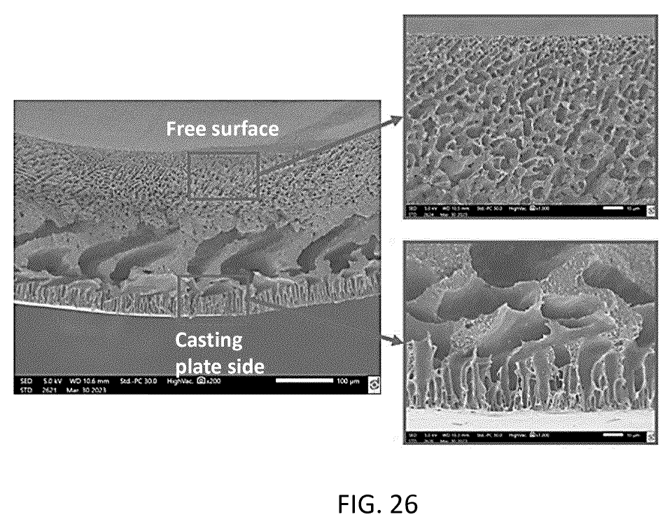

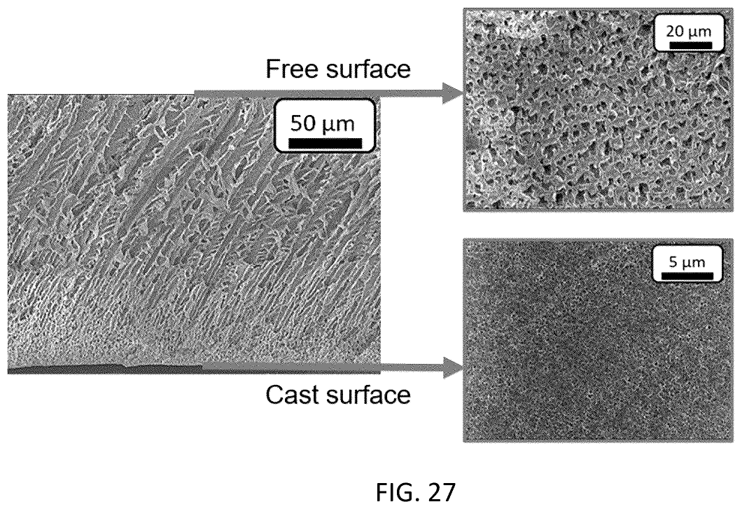

FIGS. 25, 26, and 27 display the results for the PVDF membranes. FIG. 25 is the membrane performance plot. At a cooling time of 120 s, membranes were observed to have channel pores near the free surface, small pores near the casting plate surface, and large pores between the small pores and channel pores which may be owed to the high PVDF concentration used (18.5 wt-%) and the large casting thickness (700 μm) (FIG. 26). Other samples having a cooling time of 120 s resulted in membranes having a membrane morphology similar to the membrane cross-sectional scanning electron micrograph of FIG. 27. Such membranes include small pores at the casting plate side, large pores at the free side, and channel pores between the small pores and large pores.

### Example 2: Formation and Analysis of Various Poly(Ether Sulfone) Membranes

Various poly(ethersulfone) (PES) porous membranes were made and characterized. Membranes were made according to method 100 (FIG. 7) of the present disclosure. In the present example, the method is referred to as unidirectional solvent crystallization (USC). Briefly, a casting solution of PES (Mw=72 kDa) and dimethyl sulfoxide (DMSO) was deposited onto an aluminum substrate. The aluminum substrate was chilled to a cooling temperature. The cast film was exposed to the cooling temperature for a cooling time. Following the cooling time, the cooled cast film was submerged in a water bath (nonsolvent). Seven membranes (S1-S7, Table 4) were formed by varying the concentration of the PES in the casting solvent, the membrane thickness, the cooling temperature. the cooling time, the nonsolvent temperature, and the presence or absence of a poly(ethylene glycol) (Mn=6 kDa) were varied.

TABLE 4
Parameters for formation of PES membranes S1-S7 (average pore
size is the average pore size of the selective layer)

| | PES | Casting | Cooling | Nonsolvent | Cooling | | Average |
|---|---|---|---|---|---|---|---|
| | conc. | thickness | Temperature | Temperature | Time | Additives | pore size |
| | (wt-%) | (μm) | (° C.) | (° C.) | (sec) | (—) | (nm) |
| S1 | 18.5 | 500 | −30 | 22 | 1 | None | 70 |
| S2 | 18.5 | 500 | −30 | 22 | 4 | None | 100 |
| S3 | 18.5 | 200 | −30 | 22 | 1 | None | 200 |
| S4 | 18.5 | 500 | −40 | 22 | 0.5 | PEG 6 | 250 |
| | | | | | | kDa | |
| S5 | 18.5 | 200 | −15 | 22 | 0.5 | None | 200 |
| S6 | 25 | 500 | −40 | 22 | 10 | None | 55 |
| S7 | 25 | 200 | −40 | 22 | 10 | None | 42 |

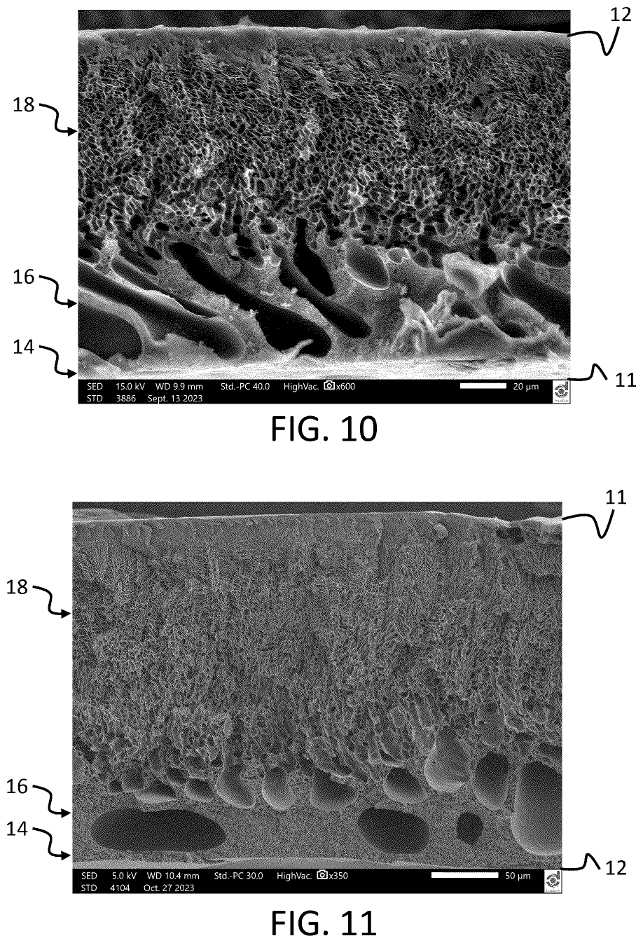

FIGS. 8-14 are cross-sectional scanning electron micrographs of membranes formed from S1-S7 (FIG. 8=S1; FIG. 9=S2; FIG. 10=S3, FIG. 11=S4, FIG. 12=S5, FIG. 13=S6, FIG. 14=S7).

FIG. 8 shows a PES membrane cross-section prepared using S1 conditions and demonstrates the formation of two distinctive sublayers. The first sublayer is of channel pores extending towards the free surface while a second sublayer includes macropores near the casting plate surface. By increasing the cooling time from 1 to 4 minutes (S2), FIG. 9 shows the increase in the channel pores proportion of the cross-section in comparison to FIG. 8. Decreasing the thickness from 500 nm to 200 nm (S3), FIG. 10 shows the channel pores seen in FIG. 8 are less distinguished and instead a sponge-like pore structure is observed. When PEG 6 kDa was added to the solution (S4) it increased the cast film hygroscopicity. This resulted in higher diffusion of the water from the nonsolvent bath through the film. As a consequence, the channel pores proportion of the cross-section increased when comparing FIG. 11 (with PEG) to FIG. 8 (without PEG). In S6 and $7, the PES concentration was increased to 25 wt-% (compared to 18.5 wt-% for samples 1 to 5). The higher PES concentration created denser membrane structures shown by the lower mean flow pore sizes (55 and 42 nm, respectively) and complete removal of the macroporous sublayer. The morphology of S6 (FIG. 13) and S7 (FIG. 14) shows an hour-glass-like structures with larger pores close to the free surface and the casting surface, with smallest pores forming between the two.

### Example 3: Temperature Analysis of the Substrate on which the Membrane is Cast During the Membrane Formation Process

A plate on which a porous polymeric membrane of the present disclosure may be formed was exposed to a variety of temperature conditions to model the temperature profile of the plate throughout the membrane formation process.

A 0.8 mm thick stainless steel plate was attached to a thermocouple. Throughout the process, the thermocouple measured the temperature of the substrate. A cap with a flow of 150 liters per hour of dried compressed air was placed above the plate. The substrate was exposed to three different conditions. First, the substrate was exposed to the compressed air. Next, the substrate was exposed to a Peltier cooling element set to a temperature of −10° C., −20° C., or −40° C. for 400 seconds. During this step, the thermocouple measured the temperature of the side of the plate not in direct contact with the cooling element. Lastly, the substrate was immersed in 20° C. water.

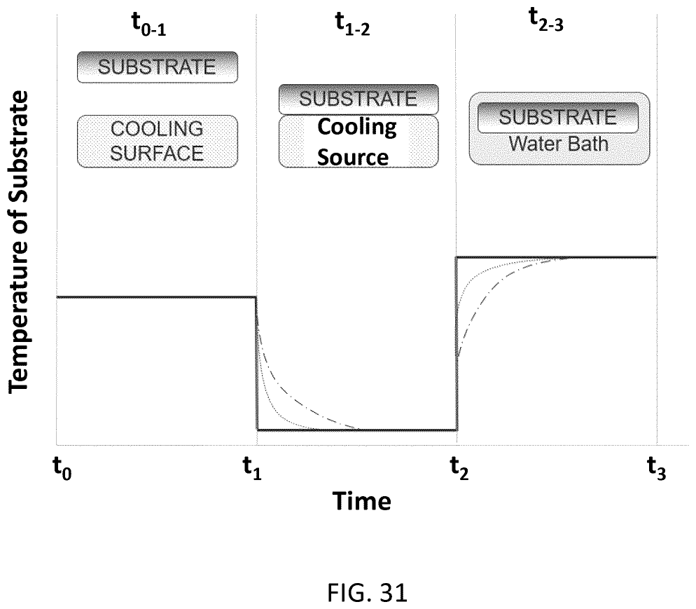

FIG. 31 is a graphical representation of an expected substrate (plate) temperature profile as the substrate was exposed to each of the three conditions. The temperature of the substrate is expected to decrease once the substrate is exposed to the cooling source (in this case, a cooling surface) as compared to when the substrate is not in contact with the cooling source or the water bath. The temperature of the substrate is expected to increase when the substrate is transferred from contact with the cooling source to being submerge in the water bath. Upon exposure to each condition, the temperature of the substrate may take a period of time to equilibrate and reach the desired temperature (shown as the dashed lines in FIG. 31). The equilibration time may influence the time the substrate is exposed to each condition.

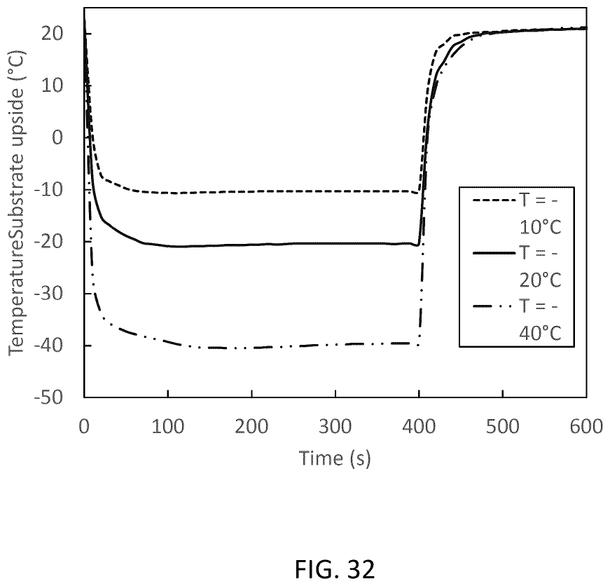

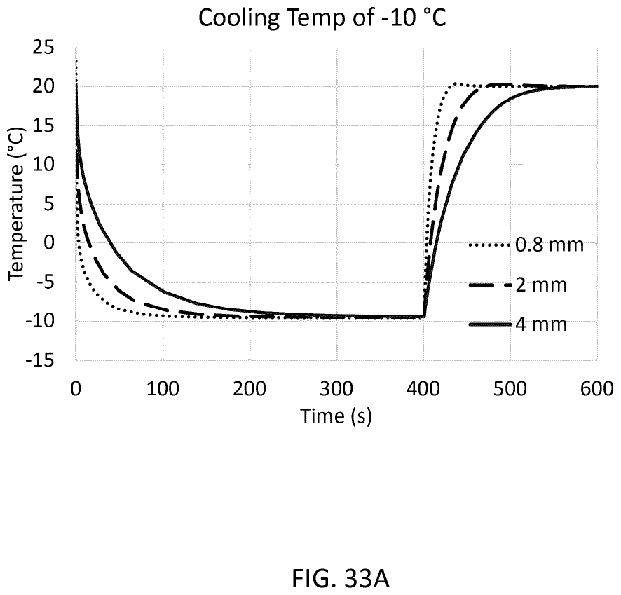

FIG. 32 shows the experimental temperature profile of the substrates that were exposed to the same initial temperature and water bath temperature but different cooling temperatures (−10° C., −20° C., or −40° C.). In FIG. 32, 0 min is when the plate was initially exposed to the cooling temperature. When cooling to −40° C., the substrate reached −30° C. within 15 seconds of exposure.

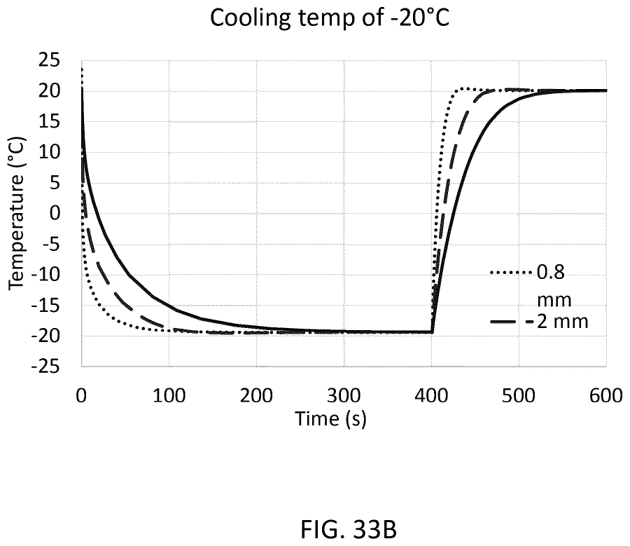

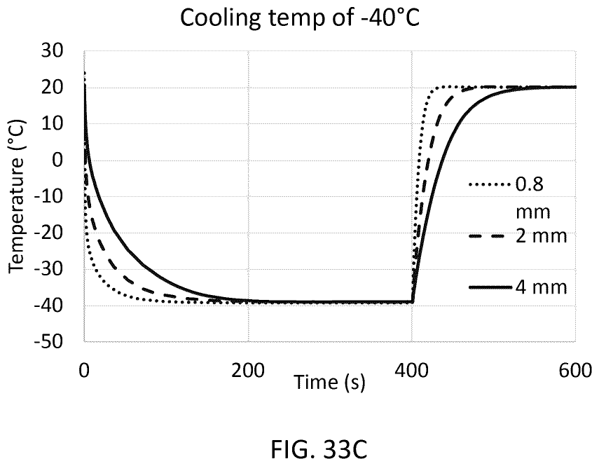

Computational simulations were run to evaluate the potential impact of changing the substrate thickness on the temperature profile of the substrate throughout the membrane formation process. Simulations were run for exposing substrates having a thickness 0.8 mm, 2 mm, or 4 mm to a cooling temperature of −10° C., −20° C., or −40° C. for 400 seconds. Following cooling, the simulation included exposing the substrates to a 20° C. water bath. FIGS. 33A, 33B, and 33C show the simulation results. Generally, the thicker the substrate the longer it took to reach the cooling temperature and the water bath temperature.

All references and publications cited herein are expressly incorporated by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

1. A polymeric porous membraned formed by a method;
the polymeric porous membrane having a first major membrane surface and a second major membrane surface opposite of the first major membrane surface, the membrane comprising:
a first layer proximate the first major membrane surface, the first layer comprising a first plurality of pores having an average pore size;
a second layer proximate the second major membrane surface, the second layer comprising a second plurality of pores having an average pore size larger than the average pore size of the first plurality of pores;
the method comprising:
contacting a casting solution with a substrate to form a cast film having a first major film surface and a second major film surface opposite of the first film major surface, the first film major surface in contact with the substrate and forming the first major membrane surface, and the second film major surface being a free surface forming the second membrane major surface, the casting solution comprising:
a casting solvent having a casting solvent melting temperature; and
a polymer dissolved in the casting solvent;
exposing the first film major surface to a cooling temperature that is less than the melting temperature of the casting solvent for a cooling time to form a cooled cast film; and
contacting the cooled cast film with a nonsolvent to remove at least a portion of the casting solvent and to form the cast membrane, the nonsolvent being at a nonsolvent temperature that is equal to or greater than the melting temperature of the casting solvent to from the cast membrane.

2. The method of claim 1, wherein the average pore size of the first plurality of pores is 20 nm to 500 nm.

3. The method of claim 1, wherein the average pore size of the first plurality of pores is 20 nm to 200 nm.

4. The method of claim 1, wherein the average pore size of the first plurality of pores is 20 nm to 80 nm.

5. The method of claim 1, wherein the average pore size of the second plurality of pores is 200 nm to 499 nm.

6. The method of claim 1, wherein the average pore size of the second plurality of pores is 0.5 μm to 2 μm.

7. The method of claim 1, wherein the polymer comprises poly(vinyl fluoride), poly(ether ketone), sulfonated poly(ether ketone), poly(benzimidazole), poly(ether sulfone), poly(sulfone), cellulose acetate, cellulose tri-acetate, regenerated cellulose, poly(acrylonitrile), poly(methyl acrylate), sulfonated poly(benzimidazole), poly(imide), poly(lactic acid), poly(vinyl alcohol), poly(vinyl chloride), poly(methyl methacrylate), ethylene vinyl alcohol copolymer, poly(L-lactide), poly(DL-lactide), poly(ether ether ketone), sulfonated poly(ether ether ketone), oligodimethylsiloxane-grafted aromatic poly(amide-imide) copolymer, perfluorosulfonated poly(arylene ether sulfone) multiblock copolymer, cyclodextrin polymer, or any mixtures thereof.

8. The method of claim 1, wherein the polymeric porous membrane has a CWP of 25 L m⁻² h⁻¹bar⁻¹ to 1200 L m⁻²h⁻¹bar⁻¹ or 4000 L m⁻²h⁻¹bar to 15000 L m⁻²h⁻¹bar⁻¹.

9. The method of claim 1, wherein the cooling temperature is 40° C. to 90° C. below the melting temperature of the casting solvent.

10. The method of claim 1, wherein the cooling temperature is −80° C. to −10° C. or −60° C. to −30° C.

11. The method of claim 1, where the melting temperature of the casting solvent is −110° C. to 80° C.

12. The method of claim 1, where the melting temperature of the casting solvent is 5° C. to 20° C., 65° C. to 75° C., −10° C. to −20° C., or −40° C. to −50° C.

13. The method of claim 1, wherein the casting solvent includes acetic acid, acetone, acetonitrile, t-butyl alcohol, caprolactam, cyclohexane, dimethylacetamide, dimethylformamide, dimethyl sulfoxide, dioxane, ethyl lactate, glycerin, methylsulfonylmethane, N-methyl pyrrolidone, gamma-valerolactone, valerolactam, caprolactone, caprolactam, hexamethylphosphoroamide, glycerol, sulfolane, tetrahydrofuran, gamma butyrolactone, dimethyl imidazolidine, or any combination thereof.

14. The method of claim 1, wherein the nonsolvent comprises water.

15. A polymeric porous membrane having a first major membrane surface and a second major membrane surface opposite of the first major membrane surface, the membrane comprising:
a first layer proximate the first major membrane surface, the first layer comprising a first plurality of pores having a first average pore size;
a second layer comprising a second plurality of pores having a second average pore size, the second pore size being greater than the first average pore size; and
a third layer proximate the second major membrane surface, the third layer comprising a third plurality of pores having a third average pore size, the third average pore size being smaller than second average pore size.

16. The polymeric porous membrane of claim 15, where the third average pore size is greater than the first average pore size.

17. The polymeric porous membrane of claim 15, wherein the first average pore size 20 nm to 499 nm and the second average pore size is greater than 3 μm.

18. A polymeric porous membrane having a first major membrane surface and a second major membrane surface opposite of the first major membrane surface, the membrane comprising:
a first layer proximate the first major membrane surface, the first layer comprising a first plurality of pores having a first average pore size;
a second layer comprising a second plurality of pores having a second average pore size, the second average pore size being smaller than the first average pore size; and
a third layer proximate the second major membrane surface, the third layer comprising a third plurality of pores having a third average pore size, the third average pore size being greater than the second average pore size.

19. The polymeric porous membrane of claim 18, wherein the second average pore size is 20 nm to 499 nm.

20. The polymeric porous membrane of claim 18, wherein the first average pore size is 20 nm to 499 nm, the third average pore size is 20 nm to 499 nm, or both.
